(19) United States
(12) Patent Application Publication
(10) Pub. No.: US 2017/0332352 A1
(43) Pub. Date: Nov. 16, 2017

(54) METHOD AND APPARATUS FOR SELECTING BETWEEN OVERLAPPING AND NON-OVERLAPPING RESOURCE POOLS FOR VEHICLE (V2X) COMMUNICATIONS

(71) Applicant: SHARP Laboratories of America, Inc., Camas, WA (US)

(72) Inventor: Jia SHENG, Vancouver, WA (US)

(21) Appl. No.: 15/592,869

(22) Filed: May 11, 2017

Related U.S. Application Data
(60) Provisional application No. 62/335,609, filed on May 12, 2016.
(60) Provisional application No. 62/336,606, filed on May 14, 2016.

(51) Int. Cl. H04W 72/02; H04W 72/04; H04L 29/08

(52) U.S. Cl. CPC H04W 72/02; H04L 67/12; H04W 72/042

(57) ABSTRACT

A wireless terminal configured for use in vehicle (V2X) communications comprises a transmitter, a memory, and processor circuitry. The transmitter is configured to send a V2X communication using a selected radio resource. The memory is configured to store information regarding data radio resources which belong to an overlapping data radio resource pool and data radio resources which belong to a non-overlapping data radio resource pool. The processor circuitry is configured to make selection of the selected radio resource from among the overlapping data radio resource pool and the non-overlapping data radio resource pool.

This application claims the priority and benefit of (1) U.S. Provisional Patent Application 62/335,609, filed May 12, 2016, which is incorporated by reference herein in its entirety; and (2) U.S. Provisional Patent Application 62/336,606, filed May 14, 2016, which is incorporated by reference herein in its entirety.

### TECHNICAL FIELD

The technology relates to wireless communications, and particularly to selecting radio resources for vehicle (V2X) communications, and more particularly to selecting between pools of radio resources for V2X communications.

### BACKGROUND

When two user equipment terminals (e.g., mobile communication devices) of a cellular network or other telecommunication system communicate with each other, their data path typically goes through the operator network. The data path through the network may include base stations and/or gateways. If the devices are in close proximity with each other, their data path may be routed locally through a local base station. In general, communications between a network node such as a base station and a wireless terminal is known as “WAN” or “Cellular communication”.

It is also possible for two user equipment terminals in close proximity to each other to establish a direct link without the need to go through a base station. Telecommunications systems may use or enable device-to-device (“D2D”) communication, in which two or more user equipment terminals directly communicate with one another. In D2D communication, voice and data traffic (referred to herein as “communication signals” or “communications”) from one user equipment terminal to one or more other user equipment terminals may not be communicated through a base station or other network control device of a telecommunication system. “Device-to-device (“D2D”) communication may also be known as “sidelink direct” communication (e.g., sidelink communication), or even as “sidelink”, “SL”, or “SLD” communication.

D2D or sidelink direct communication can be used in networks implemented according to any suitable telecommunications standard. A non-limiting example of such as standard is the 3rd Generation Partnership Project (“3GPP”) Long Term Evolution (“LTE”). The 3GPP standard is a collaboration agreement that aims to define globally applicable technical specifications and technical reports for third and fourth generation wireless communication systems. The 3GPP may define specifications for next generation mobile networks, systems, and devices.

Currently 3GPP is specifying a new feature for Rel-14 that covers use cases and potential requirements for LTE support for vehicular communications services (represented by the term, Vehicle-to-Everything (V2X) Services). The feature is documented in the TR 22.885 on LTE Study on LTE Support for V2X Services. Contemplated V2X services may include one or more of the following:
V2V: covering LTE-based communication between vehicles.
V2P: covering LTE-based communication between a vehicle and a device carried by an individual (e.g. handheld terminal carried by a pedestrian, cyclist, driver or passenger).
V2I: covering LTE-based communication between a vehicle and a roadside unit. A roadside unit (RSU) is a transportation infrastructure entity (e.g. an entity transmitting speed notifications).

Thus far 3GPP deliberations concerning synchronization for vehicle-to-vehicle (V2V) communications have essentially assumed reuse of LTE sidelink for V2V, e.g., assumed that the V2V communications will essentially be indistinct from sidelink direct communications in the access stratum (AS), e.g., may use the same PC5 radio access interface. As such, it has generally been assumed that the LTE 3GPP resource selection design for SLD would be reused for V2X communication as much as possible. On the other hand, there are still numerous differences between V2X and D2D, such as higher V2X user equipment (UE) density and much higher V2X UE velocity.

What is needed are methods, apparatus, and/or techniques for selecting between pools comprising overlapping radio resources and pools comprising non-overlapping radio resources for vehicle (V2X) communications.

### SUMMARY

In one of its aspects the technology disclosed herein concerns a wireless terminal configured for use in vehicle (V2X) communications comprising a transmitter, a memory, and processor circuitry. The transmitter is configured to send a V2X communication using a selected radio resource. The memory is configured to store information regarding data radio resources which belong to an overlapping data radio resource pool and data radio resources which belong to a non-overlapping data radio resource pool. The processor circuitry is configured to make selection of the selected radio resource from among the overlapping data radio resource pool and the non-overlapping data radio resource pool.

In an example embodiment and mode the memory is configured to store information regarding the data radio resources each of which are classified in accordance with one of plural data radio resource pool types including data radio resource pool Type 1 and data radio resource pool Type 2. One or more Type 1 data resource pools are classified as belonging to data resource pool Type 1 and one or more Type 2 data resource pools are classified as belonging to data resource pool Type 2. The one or more Type 1 data resource pools consist of radio resources that are included in plural data resource pools and the one or more Type 2 data resource pools consist of radio resources that are included in only one of the plural Type 2 data resource pools. The processor circuitry is configured to make a pool type selection of a selected data resource pool type from which the selected radio resource is selected; the selected resource pool type being either the Type 1 data resource pool type or the Type 2 data resource pool type.

In another of its aspects the technology disclosed herein concerns a method of operating a wireless terminal configured for use in vehicle (V2X) communications. In a basic mode the method comprises: classifying data radio resources as belonging to one of an overlapping data radio resource pools and a non-overlapping data radio resource pool; using processor circuitry to make selection of a selected radio resource from among the overlapping data radio resource pools and the non-overlapping data radio resource pool; and, transmitting a V2X communication using the selected radio resource.

In another of its aspects the technology disclosed herein concerns a node of a radio access network (RAN) comprising processor circuitry and a transmitter. The processor circuitry is configured to provide pool type selection information to a wireless terminal configured to participate in a vehicle (V2X) communication. The pool type selection information comprises criteria to facilitate selection by the wireless terminal between data radio resource pool Type 1 and data radio resource pool Type 2 as a selected data resource pool from which the wireless terminal selects a radio resource for the V2X communication. The one or more Type 1 data resource pools are classified as belonging to data resource pool Type 1 and one or more Type 2 data resource pools are classified as belonging to data resource pool Type 2. The one or more Type 1 data resource pools consist of radio resources that are included in plural data resource pools and the one or more Type 2 data resource pools consist of radio resources that are included in only one of the plural Type 2 data resource pools. The transmitter is configured to transmit the pool type selection criteria information to the wireless terminal.

### BRIEF DESCRIPTION OF THE DRAWINGS

The foregoing and other objects, features, and advantages of the technology disclosed herein will be apparent from the following more particular description of preferred embodiments as illustrated in the accompanying drawings in which reference characters refer to the same parts throughout the various views. The drawings are not necessarily to scale, emphasis instead being placed upon illustrating the principles of the technology disclosed herein.

FIG. 1 is a diagrammatic view showing generally three scenarios which may occur in vehicle (V2X) communication, i.e., an in coverage vehicle (V2X) communication scenario; a partial coverage vehicle (V2X) communication scenario; and an out-of-coverage vehicle (V2X) communication scenario.

FIG. 2 is a diagrammatic view showing that, in differing implementations, V2X communication may be implemented either in conjunction with sidelink direct (SLD) communication, in conjunction with enhanced SLD, or apart from SLD as a separate V2X communication protocol.

FIG. 3 is a diagrammatic view of illustrating a problem of selecting resources when there are both overlapping data radio resource pools and non-overlapping data radio resource pools.

FIG. 4A and FIG. 4B are diagrammatic views of example radio resource pool(s) structures, FIG. 4A illustrating a common Type 1 data pool shared by wireless terminals and FIG. 4B illustrating (as a non-limiting example) multiple Type 1 pools

FIG. 5 is a schematic view of an example embodiment of a generic wireless terminal configured to implement pool type selection for selecting a data radio resource pool from which a data radio resources may be selected for vehicle (V2X) communications.

FIG. 6 is a flowchart showing example basic acts or steps performed by a wireless terminal in a pool type selection procedure for selecting a data radio resource pool from which a data radio resources may be selected for vehicle (V2X) communications.

FIG. 7-1 through FIG. 7-6 are flowcharts shows example acts or steps which may be performed by a pool type selection controller executing differing example alternatives A.1-A.6 of a first embodiment of a pool type selection procedure.

FIG. 8-1 through FIG. 8-6 are flowcharts shows example acts or steps which may be performed by a pool type selection controller executing differing example alternatives B.1-B.6 of a second embodiment of a pool type selection procedure.

FIG. 9-1 through FIG. 9-6 are flowcharts shows example acts or steps which may be performed by a pool type selection controller executing differing example alternatives C.1-C.6 of a third embodiment of a pool type selection procedure.

FIG. 10 is a schematic view of an example node of a cellular radio access network configured to facilitate implementation of pool type selection by a wireless terminal for vehicle (V2X) communications.

FIG. 11 is a diagrammatic view showing example elements comprising electronic machinery which may comprise a wireless terminal according to an example embodiment and mode.

### DETAILED DESCRIPTION

In the following description, for purposes of explanation and not limitation, specific details are set forth such as particular architectures, interfaces, techniques, etc. in order to provide a thorough understanding of the technology disclosed herein. However, it will be apparent to those skilled in the art that the technology disclosed herein may be practiced in other embodiments that depart from these specific details. That is, those skilled in the art will be able to devise various arrangements which, although not explicitly described or shown herein, embody the principles of the technology disclosed herein and are included within its spirit and scope. In some instances, detailed descriptions of well-known devices, circuits, and methods are omitted so as not to obscure the description of the technology disclosed herein with unnecessary detail. All statements herein reciting principles, aspects, and embodiments of the technology disclosed herein, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that block diagrams herein can represent conceptual views of illustrative circuitry or other functional units embodying the principles of the technology. Similarly, it will be appreciated that any flow charts, state transition diagrams, pseudocode, and the like represent various processes which may be substantially represented in computer readable medium and so executed by a computer or processor, whether or not such computer or processor is explicitly shown.

As used herein, the term “device-to-device (“D2D”) communication” may refer to a mode of communication between or among wireless terminals that operate on a cellular network or other telecommunications system in which the communication data traffic from one wireless terminal to another wireless terminal does not pass through a centralized base station or other device in the cellular network or other telecommunications system. The “device-to-device (D2D) communication” encompasses one or both of D2D signaling (e.g., D2D control information) and D2D data. “Device-to-device (“D2D”) communication may also be known as “sidelink direct” communication (e.g., sidelink communication). The term “sidelink direct” may also be shortened to “sidelink”, abbreviated as “SL”, and as such “sidelink” may be used herein to refer to sidelink direct. Yet further, the term “ProSe” (Proximity Services) direct communication may be used in lieu of sidelink direct communication or device-to-device (D2D) communication. Therefore, it is to be understood that herein the terms “sidelink direct”, ‘sidelink” (SL), “ProSe” and “device-to-device (D2D)” may be interchangeable and synonymous.

Thus, as mentioned above, device-to-device (D2D) or sidelink direct communication differs from “WAN” or “Cellular communication” which is or involves communication between the base station and the wireless terminal. In device-to-device (D2D) communication, communication data is sent using communication signals and can include voice communications or data communications intended for consumption by a user of a wireless terminal. Communication signals may be transmitted directly from a first wireless terminal to a second wireless terminal via D2D communication. In various aspects, all, some or none of the control signaling related to the D2D packet transmission may be managed or generated by the underlying core network or base station. In additional or alternative aspects, a receiver user equipment terminal may relay communication data traffic between a transmitter user equipment terminal and one or more additional receiver user equipment terminals.

As used herein, the term “core network” can refer to a device, group of devices, or sub-system in a telecommunication network that provides services to users of the telecommunications network. Examples of services provided by a core network include aggregation, authentication, call switching, service invocation, gateways to other networks, etc.

As used herein, the term “wireless terminal” can refer to any electronic device used to communicate voice and/or data via a telecommunications system, such as (but not limited to) a cellular network. Other terminology used to refer to wireless terminals and non-limiting examples of such devices can include user equipment terminal, UE, mobile station, mobile device, access terminal, subscriber station, mobile terminal, remote station, user terminal, terminal, subscriber unit, cellular phones, smart phones, personal digital assistants (“PDAs”), laptop computers, tablets, netbooks, e-readers, wireless modems, etc.

As used herein, the term “access node”, “node”, or “base station” can refer to any device or group of devices that facilitates wireless communication or otherwise provides an interface between a wireless terminal and a telecommunications system. A non-limiting example of a base station can include, in the 3GPP specification, a Node B (“NB”), an enhanced Node B (“eNB”), a home eNB (“HeNB”) or some other similar terminology. Another non-limiting example of a base station is an access point. An access point may be an electronic device that provides access for wireless terminal to a data network, such as (but not limited to) a Local Area Network (“LAN”), Wide Area Network (“WAN”), the Internet, etc. Although some examples of the systems and methods disclosed herein may be described in relation to given standards (e.g., 3GPP Releases 8, 9, 10, 11, 12, 13, and thereafter), the scope of the present disclosure should not be limited in this regard. At least some aspects of the systems and methods disclosed herein may be utilized in other types of wireless communication systems.

As used herein, the term “telecommunication system” or “communications system” can refer to any network of devices used to transmit information. A non-limiting example of a telecommunication system is a cellular network or other wireless communication system.

As used herein, the term “cellular network” or “cellular radio access network” can refer to a network distributed over cells, each cell served by at least one fixed-location transceiver, such as a base station. A “cell” may be any communication channel that is specified by standardization or regulatory bodies to be used for International Mobile Telecommunications-Advanced (“IMTAdvanced”). All or a subset of the cell may be adopted by 3GPP as licensed bands (e.g., frequency band) to be used for communication between a base station, such as a Node B, and a UE terminal. A cellular network using licensed frequency bands can include configured cells. Configured cells can include cells of which a UE terminal is aware and in which it is allowed by a base station to transmit or receive information. Examples of cellular radio access networks include E-UTRAN, and any successors thereof (e.g., NUTRAN).

Vehicle (V2X) communication is described in one or more of the following (all of which are incorporated herein by reference in their entirety):

Incorporated herein by reference are the following:
3GPP TS 36.331 V13.0.0 “Evolved Universal Terrestrial Radio Access (E-UTRA); Radio Resource Control (RRC); Protocol specification”, including but not limited to §5.10.3 (Sidelink communication monitoring), §5.10.4 (Sidelink communication transmission), and §9.3.2 (pre-configurable parameters).
RP-151109, Feasibility Study on LTE-based V2X Services 3GPP TSG RAN Meeting #68, Malmö, Sweden, Jun. 15-18, 2015.
RP-152293, Support for V2V services based on LTE sidelink, 3GPP TSG RAN Meeting #70, Sitges, Spain, Dec. 7-10, 2015
3GPP TSG RAN WG1 Meeting #84 bis, Busan, Korea Apr. 11-15, 2016, Chairman notes.
3GPP TR 22.885 V14.0.0 3rd Generation Partnership Project; Technical Specification Group Services and System Aspects; Study on LTE Support for V2X Services (Release 14).

Vehicle (V2X) communication is a communication that involves a radio connection established between a transmit device and a receive device (e.g., a wireless terminal or UE), which radio communication may or may not transit via a base station node of the network, with at least of one the transmit device and the receive device being mobile, e.g., capable of being moved. Generic V2X encompasses one or more of vehicle to infrastructure (V2I) communication; vehicle to person/pedestrian (V2P) communication; and vehicle to vehicle (V2V) communication.

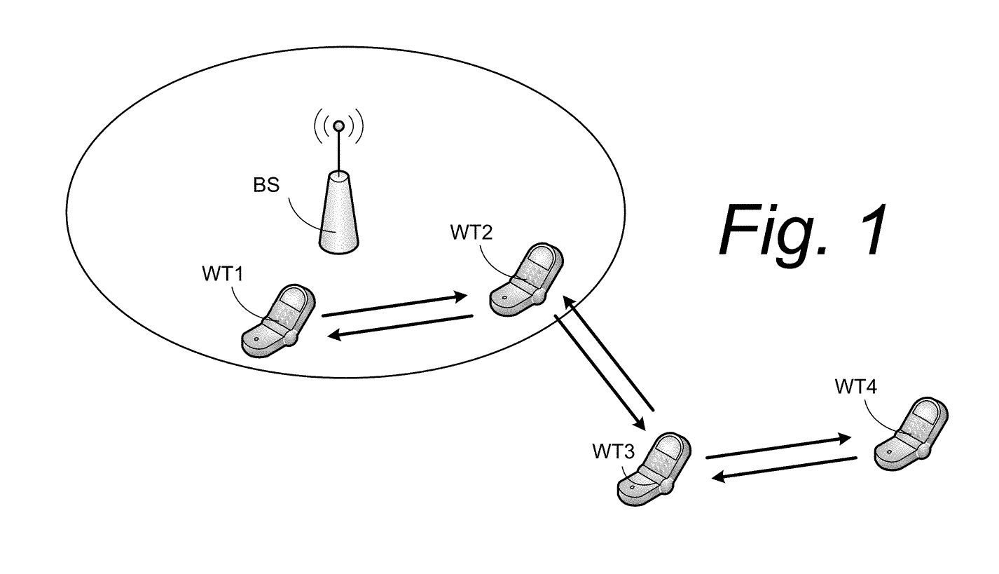

Generally, there are three general scenarios which may occur in vehicle (V2X) communication. Those three general vehicle (V2X) communications scenarios are illustrated in FIG. 1. A first vehicle (V2X) communication scenario is an “in coverage” vehicle (V2X) communication scenario, illustrated between WT1 and WT2 of FIG. 1, in which both WT1 and WT2 are within coverage of the cellular radio access network. A second vehicle (V2X) communication scenario is a “partial coverage” scenario, illustrated between WT2 and WT3 of FIG. 1. In the “partial coverage” vehicle (V2X) communication scenario the wireless terminal WT2 is within coverage of the cellular radio access network, but the wireless terminal WT3 is out-of-coverage of the cellular radio access network. A third vehicle (V2X) communication scenario is an “out-of-coverage” scenario, illustrated between wireless terminal WT3 and wireless terminal WT4 of FIG. 1. In the out-of-coverage vehicle (V2X) communication scenario both the wireless terminal WT3 and the wireless terminal WT4 are out-of-coverage of the cellular radio access network.

The three vehicle (V2X) communication scenarios are described with reference to whether or not a participating wireless terminals (e.g., WTs) are “in coverage” or “out-of-coverage” of one or more cellular radio access networks (which may collectively be referred to as a “cellular radio access network”). For sake of simplicity FIG. 1 depicts “coverage” as being with respect to an access node BS such as eNodeB which comprises a cellular radio access network. It should be understood, however, that a wireless terminal may also be in coverage of the cellular radio access network when served by any cell of the cellular radio access network(s). For example, if wireless terminal WT1 and wireless terminal WT2 were served by different cells, when participating in vehicle (V2X) communication the wireless terminal WT1 and wireless terminal WT2 would still be in an in coverage vehicle (V2X) communication scenario.

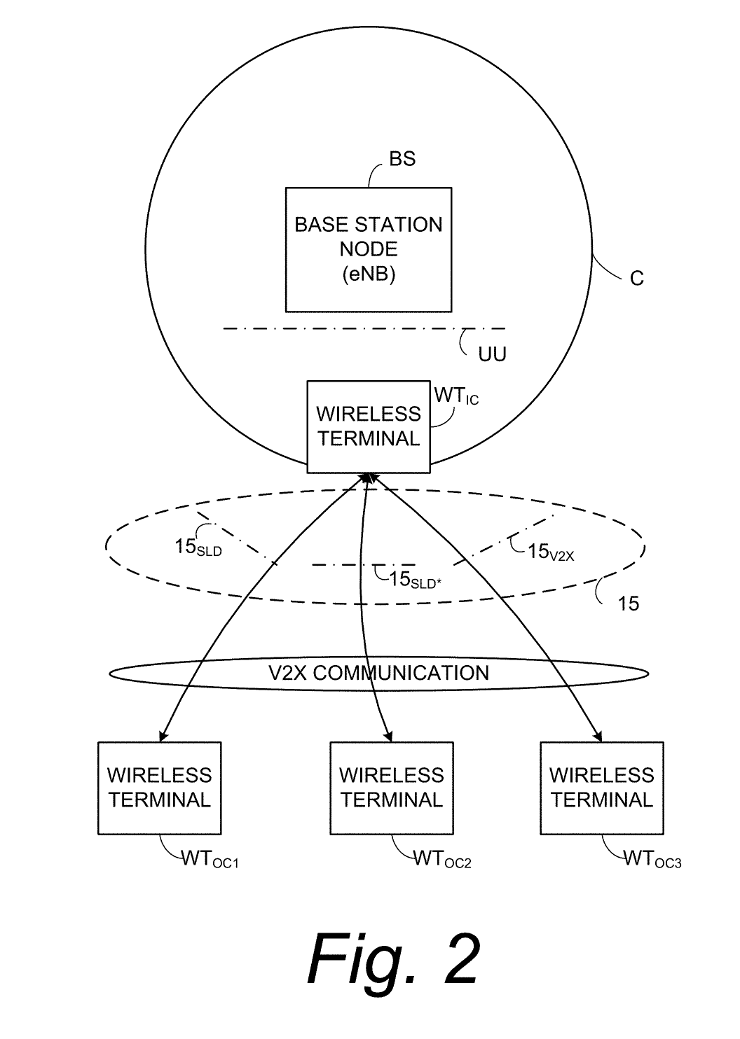

As used herein and as illustrated in FIG. 2, V2X communication may be implemented in several ways. For illustrative context, FIG. 2 illustrates a base station node BS of a cellular radio access network which serves a cell C. The base station BS may communicate with a wireless terminal WT_{IC} which is in coverage of the cellular radio access network over a radio interface UU. FIG. 2 further shows that wireless terminal WT_{IC} may engage in vehicle (V2X) communication with one or more other wireless terminals which are outside of coverage of the cellular radio access network, particularly wireless terminal WT_{OC1}, wireless terminal WT_{OC2}, and wireless terminal WT_{OC3}. It is assumed that either wireless terminal WT_{IC}, or all of wireless terminal WToci, wireless terminal WT_{OC2}, and wireless terminal WT_{OC3} are mobile terminals for the communication to be vehicle (V2X) communication. Being “mobile” means that the wireless terminal is provided or situated in/with a mobile entity, such as a vehicle or a person.

As a first example implementation, V2X communication may be implemented using applications and resources of the type that were utilized for sidelink direct (SLD) communication (also known as device-to-device (“D2D”) communication) before introduction of vehicle (V2X) communication. For example, when implemented as part of SLD communication the V2X communication may use resources and channels of the SLD communication scheme. In such first implementation the V2X communication may be said to be implemented using pre-V2X sidelink direct (SLD) protocol and over a pre-V2X sidelink direct (SLD) radio interface 15SLD.

As a second example implementation, V2X communication may be implemented using enhanced applications and enhanced resources utilized for sidelink direct (SLD) communication, e.g., sidelink direct communications augmented or enhanced with additional capabilities to accommodate vehicle (V2X) communication. In such second implementation the V2X communication may be said to be implemented using enhanced sidelink direct (SLD) protocol and over an enhanced sidelink direct (SLD) radio interface 15SLD*.

As a third example implementation, V2X communication may operate separately from sidelink direct (SLD) communication by, e.g., having separate and dedicated V2X communication resources and channels, and by being performed using application software which is specific to V2X communication. In such third implementation the V2X communication may be said to be implemented using separate vehicle (V2X) communications protocol and over a separate vehicle (V2X) communication radio interface 15V2X.

The fact that three example implementations are illustrated in FIG. 2 does not mean that a particular wireless terminal has to participate in all three or even two of the example implementations. FIG. 2 simply indicates the expansive meaning of the term vehicle (V2X) communication and that the technology disclosed herein encompasses vehicle (V2X) communication in all of its various existing and potential implementations.

In sidelink direct communications, a scheduling assignment (SA) is used to indicate the data radio resources that may be used to carry data in a sidelink direct transmission, e.g., to a receiving wireless terminal. As such, there may be one or more pools of scheduling assignment (SA) radio resources that are used to carry the scheduling assignment (SA) information, with the scheduling assignment (SA) resources being different than the data radio resources that are described by the scheduling assignment (SA). The data radio resources typically belong to a data pool (of data radio resources).

Any reference to a “resource” herein means “radio resource” unless otherwise clear from the context that another meaning is intended. In general, as used herein a radio resource (“resource”) is a time-frequency unit that can carry information across a radio interface, e.g., either signal information or data information. An example of a radio resource occurs in the context of a “frame” of information that is typically formatted and prepared, e.g., by a node. In Long Term Evolution (LTE) a frame, which may have both downlink portion(s) and uplink portion(s), is communicated between the base station and the wireless terminal. Each LTE frame may comprise plural subframes. For example, in the time domain, a 10 ms frame consists of ten one millisecond subframes. An LTE subframe is divided into two slots (so that there are thus 20 slots in a frame). The transmitted signal in each slot is described by a resource grid comprised of resource elements (RE). Each column of the two dimensional grid represents a symbol (e.g., an OFDM symbol on downlink (DL) from node to wireless terminal; an SC-FDMA symbol in an uplink (UL) frame from wireless terminal to node). Each row of the grid represents a subcarrier. A resource element (RE) is the smallest time-frequency unit for downlink transmission in the subframe S. That is, one symbol on one sub-carrier in the sub-frame comprises a resource element (RE) which is uniquely defined by an index pair (k, l) in a slot (where k and l are the indices in the frequency and time domain, respectively). In other words, one symbol on one sub-carrier is a resource element (RE). Each symbol comprises a number of sub-carriers in the frequency domain, depending on the channel bandwidth and configuration. The smallest time-frequency resource supported by the standard today is a set of plural subcarriers and plural symbols (e.g., plural resource elements (RE)) and is called a resource block (RB). A resource block may comprise, for example, 84 resource elements, i.e., 12 subcarriers and 7 symbols, in case of normal cyclic prefix.

According to RP-151109, Feasibility Study on LTE-based V2X Services 3GPP TSG RAN Meeting #68, Malmo, Sweden, June 15-18, 2016, V2X services should be supported by both LTE Uu interface and sidelink interface. In RP-152293, Support for V2V services based on LTE sidelink, 3GPP TSG RAN Meeting #70, Sitges, Spain, December 7-10, 2015, the LTE sidelink (also known as PC5) is studied as the baseline for V2X service. However, as mentioned above, there are numerous differences between V2X and D2D, such as higher V2X UE density and much higher V2X UE velocity.

Regarding the topic of resource pool design, 3GPP TSG RAN WG1 Meeting #84 bis, Busan, Korea April 11-15, 2016, Chairman notes (herein, “Meeting #84 bis Chairman notes”) include the following concepts:
A data pool is always associated with an SA pool.
   A resource block (RB) of a scheduling assignment (SA) pool in a transmission time interval (TTI) cannot be included in the associated data pool.
   A resource block (RB) of a scheduling assignment (SA) pool in a transmission time interval (TTI) cannot be included another SA pool (if another SA pool exists).
   At least a resource block (RB) of a data pool in a transmission time interval (TTI) can be included in another data pool (if another data pool exists).
   A resource block (RB) of an scheduling assignment (SA) pool in a transmission time interval (TTI) cannot be included an un-associated data pool (if another un-associated data pool exists)

The Meeting #84 bis Chairman notes thus prescribe 1) no overlap between SA pools and data pools, no matter whether there are linkages between them; (2) no overlap among SA pools; and, (3) possible overlap among data pools. In an extreme case of (3), there may be only one data pool shared by multiple SA pools.

Therefore, with the Meeting #84 bis Chairman notes there arises a new problem of how to handle overlapped resources (for data pool) during resource selection. This problem is new since, in the legacy sidelink communications, no data pools overlap with each other.

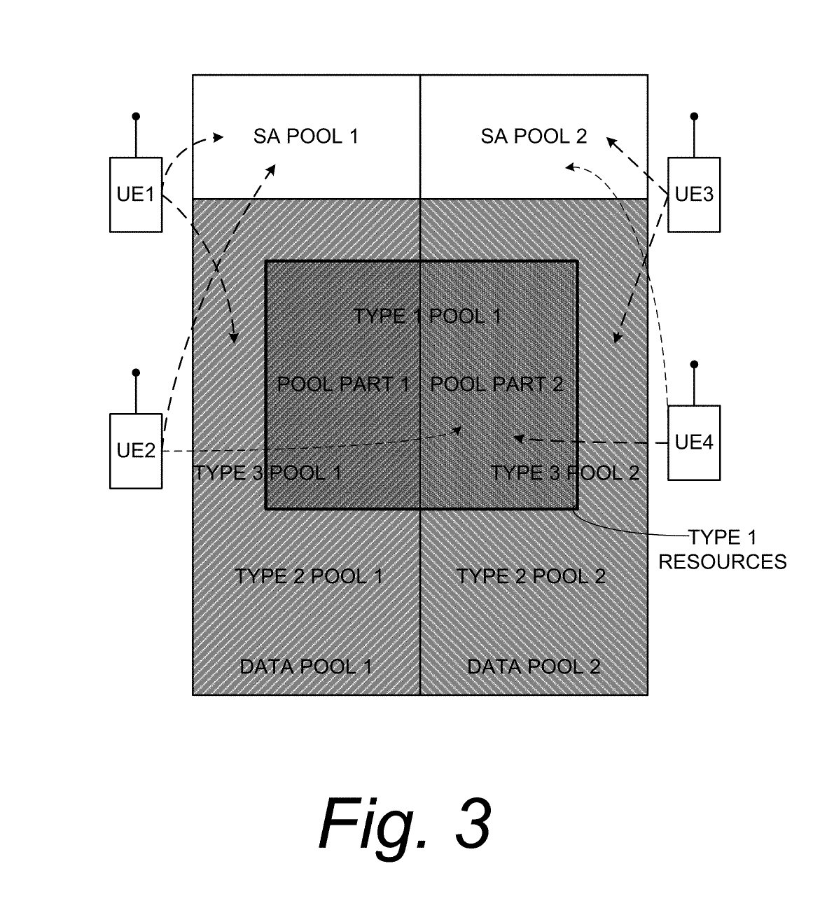

FIG. 3 illustrates the problem of selecting resources when there are both overlapping data radio resource pools and non-overlapping data radio resource pools. As shown in FIG. 3, UE1 and UE3 have non-overlapped scheduling assignment (SA) and data pools; while UE2 and UE4 have overlapped data pool although they have non-overlapped SA pools.

For convenience, the overlapped resources such as those of FIG. 3 are herein referred to as “Type 1 Resources”, which correspond to the resources “at least an RB of a data pool in a TTI can be included in another data pool (if exists)” as mentioned in the Meeting #84 bis Chairman notes. The non-overlapped resources in each data pool of FIG. 3 are referred to herein as “Type 2 Resources”. Of course, the resources can also be provided with other names (such as, e.g., reversing the nomenclature described above such that the overlapped resources as “Type 2 Resources” and the non-overlapped resources as “Type 1 Resources”).

The following statements describe the resources and pools of FIG. 3:
data pool 1 (Type 3 pool 1)=pool part 1∪pool part 3
data pool 2 (Type 3 pool 2)=pool part 2∪pool part 4
Type 2 pool 1=pool part 3
Type 2 pool 2=pool part 4
Type 1 pool 1=pool part 1∪pool part 2

Thus, as shown in FIG. 3 and used herein:
a Type 3 pool represents a legacy sidelink data pool, which includes overlapped resources and non-overlapped resources (if exist).
a Type 2 pool represents the non-overlapped resources within each legacy data pool excluding the overlapped resources with other legacy data pool(s).
a Type 1 pool represents the overlapped resources within each legacy data pool.

As the resource selection within each pool is random, UE1 and UE3 can guarantee no interference with each other no matter how they select resource within their data pool. However, UE2 and UE4 may interfere with each other because they share the same data resources. Furthermore, if the UE, e.g., UE2 randomly selects resources within Type 1 pool and the resource selected is within the data pool 2, it may also interfere with UE3. However, from a system performance point of view, scheduling UE2 and UE4 in the same pool has better efficiency than scheduling them in separate pools. Therefore, how to select between Type 1 resources and Type 2 resources, or between Type 1 pool and Type 2 pool, is a new problem arising in the context of V2X communications.

In V2X communications, the same resource can be reused by UEs far enough from each other (interference generated by using the same resource is so weak that it cannot interfere with the other UEs' communication). However, since sidelink is half duplex communication, when the UE is transmitting, it cannot detect whether there is interference from other UEs. When the UE, transmitting with resources which have no collision with nearby UEs, moves to other locations, the resources it uses may still collide with the UEs in the new locations, especially if these resources are in the same resource pool, or in the same Type 1 resource pool.

As mentioned above, a scheduling assignment (SA) carries information which specifies the data resources that may be used by the UE. Scheduling assignment (SA) decoding (SAD) and energy sensing (ES) may be used for collision avoidance. However, due to half duplex of V2V and the essence that V2V UE cannot decode all UEs' scheduling assignments (SA), the resource selection collision problem cannot be totally avoided.

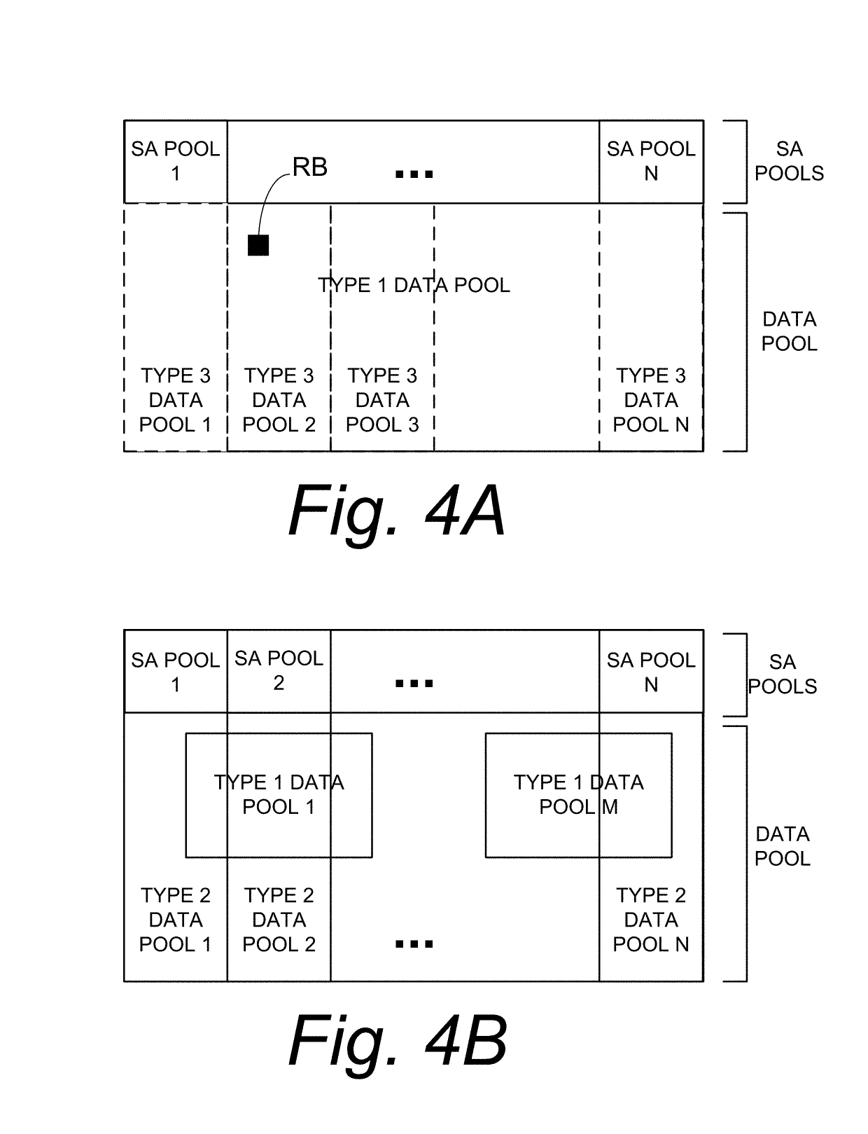

The Type 3 multiple resource pool design and resource selection have already been described in U.S. Patent Provisional Application 62/319,065 and U.S. patent application Ser. No. 15/477,299, both entitled “RESOURCE SELECTION FOR VEHICLE (V2X) COMMUNICATIONS”, and both incorporated herein by reference in their entireties. The technology disclosed herein concerns, e.g., selection between the Type 1 resources and Type 2 resources. As used herein, Type 1 resources may be just one common pool shared by all UEs (as illustrated in FIG. 4A), or multiple Type 1 data pools from multiple Type 3 pools (as illustrated in FIG. 4B). FIG. 4A and FIG. 4B are based on the facts that N≧1 and N>M and (for FIG. 4B) Type 1 data pools can exist among adjacent data pools (if there are multiple data pools). It should be noted that Type 1 data pools do not mean they are only shared by two resource pools, as there could be multiple Type 3 data pools forming one Type 1 data pool, as Type 1 data pool 1 depicted in FIG. 4B.

It should also be understood that pool segmentation can be based on some property or criteria, such as each resource pool being associated with a priority, for example. As described in U.S. Patent Provisional Application 62/319,065 and U.S. patent application Ser. No. 15/477,299, both entitled “RESOURCE SELECTION FOR VEHICLE (V2X) COMMUNICATIONS”, and both incorporated herein by reference, pool segmentation can be associated with a criteria or property other than priority, such as service type, direction, and velocity, for example.

Accordingly, the technology disclosed herein provides solutions for V2X resource selection between Type 1 and Type 2 resources. As such, the technology disclosed herein recognizes a trade-off of interference among UEs for single UE performance and scheduling efficiency for system performance, in the case of preference is given to the former purpose or to the latter purpose. In the case of no preference of purpose, the technology disclosed herein provides a dynamic design for resource pool selection.

Thus, one aspect of the technology disclosed herein concerns apparatus, method, and technique for selecting radio resources for vehicle (V2X) communications, and more particularly to selecting between overlapping pools of radio resources and non-overlapping pools of radio resources for V2X communications. As used herein, an “overlapping pool” or “overlapping data resource pool” is a pool comprising data radio resources that may populate or comprise (e.g., be shared among) other data radio resource pool(s), whereas a “non-overlapping pool” is a pool that consists of data radio resources that are associated or belong only to the one pool, i.e., the non-overlapping pool. Thus, it can be seen in the scenario of FIG. 4A, sole Type 1 Data Pool is constructed so that all of its resources, such as resource block (RB), belong to or are shared among other data pools. For example, resource block (RB) of the sole Type 1 Data Pool of FIG. 4A is essentially shared among plural Type 3 data pools, e.g., shared among each of Type 3 Data Pool 1 through and including Type 3 Data Pool N. In other words, by virtue of belonging to the “overlapping pool” of Type 1, all resource blocks of the overlapping pool are shared among plural other pools that permit such sharing. FIG. 4B, on the other hand, shows plural such overlapping data radio resource pools, with each of Type 1 Data Pool 1 and Type 1 Data Pool M having membership as above described for FIG. 4A, each resource block of each Type 1 Data Pool being shared among other pools.

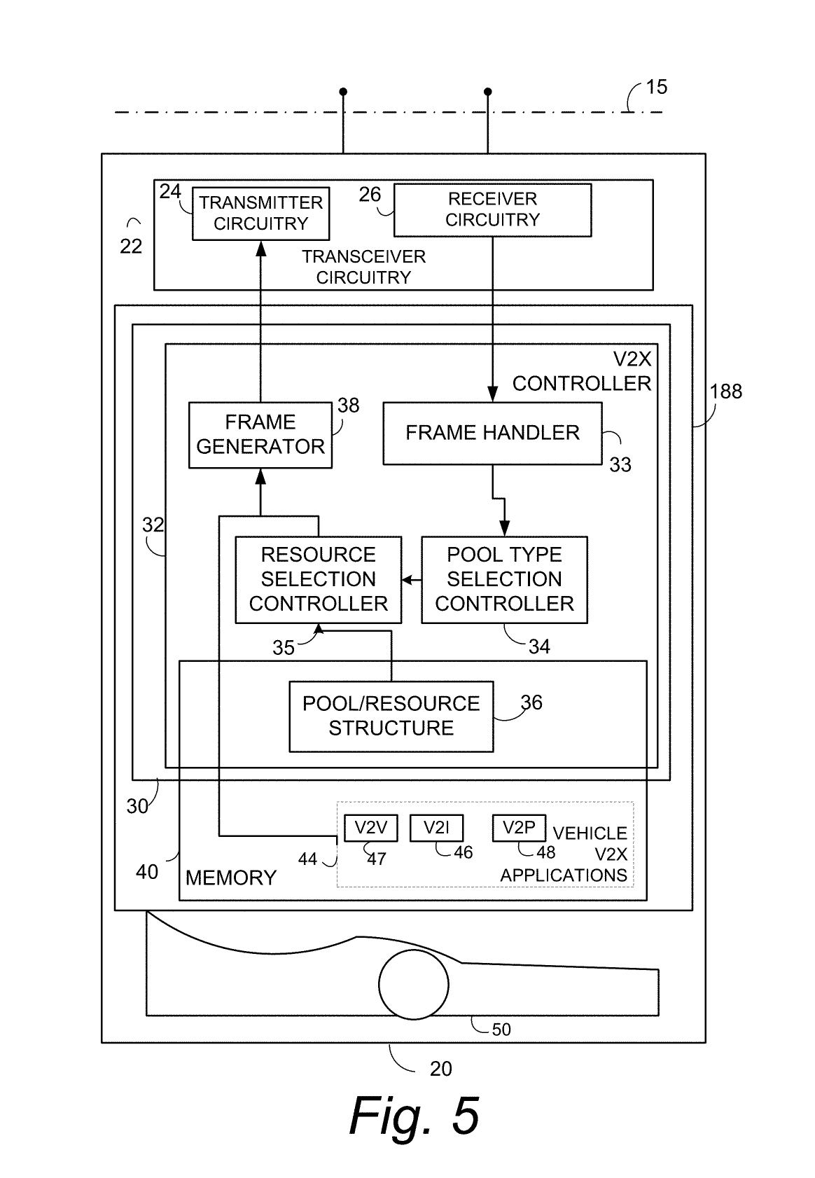

FIG. 5 shows various example, representative, non-limiting components and functionalities herein pertinent of a generic wireless terminal 20 configured for data radio resource pool type selection for vehicle (V2X) communications.

The wireless terminal 20 comprises transceiver circuitry 22, which in turn comprises transmitter circuitry 24 and receiver circuitry 26. The transceiver circuitry 22 includes antenna(e) for the wireless terminal 20. Transmitter circuitry 24 includes, e.g., amplifier(s), modulation circuitry and other conventional transmission equipment. Receiver circuitry 26 comprises, e.g., amplifiers, demodulation circuitry, and other conventional receiver equipment. The transceiver circuitry 22 is configured to use resources allocated for V2X communication, whether those resources be shared with sidelink direct (SLD) communications or separate and distinct for V2X communication as previously described.

The wireless terminal 20 further comprises processor circuitry, also herein known more simply as processor 30. While processor 30 may have responsibility for operation of many aspects of wireless terminal 20 not specifically described herein, in one of its aspects processor 30 serves as a VCX controller 32 for controlling aspects of vehicle (V2X) communication. As further illustrated in FIG. 5, the V2X controller 32 in turn comprises frame handler 33, data resource pool type selection controller 34, resource selection controller 35; resource/pool structure 36, and frame generator 38.

In addition to the processor circuitry 30, wireless terminal 20 also comprises memory 40 (e.g., memory circuitry) which may store an operating system and various application programs, such as vehicle (V2X) communication applications 44 (including V2I application 46, V2V (vehicle-to-vehicle) application 47 and V2P (vehicle-to-pedestrian) application 48, discussed above. The memory 40 may be any suitable type of memory, e.g., random access memory (RAM), read only memory (ROM), cache memory, processor register memory, or any combination of one or more memory types. The applications such as V2X applications 44 comprise instructions executable by processor circuitry 30 and are stored in non-transient portions of memory 40. At least some aspects of memory 40 may also be considered as part of V2X controller 32, and as such may host some or all of resource/pool structure 36.

The wireless terminal 20 further comprises user interface(s) 50. The user interfaces 50 may comprise one or more suitable input/output devices which are operable by a user. Some of all of the user interfaces 50 may be realized by a touch sensitive screen. The user interface(s) 50 may also comprise a keyboard, audio input and output, and other user I/O devices. Only a portion of the user interfaces 50 is depicted in FIG. 5, it being understood that the user interfaces 50 may be provided on a cover or case of wireless terminal 50 and thus may visibly obscure the underlying other components shown in FIG. 5.

In the example FIG. 5, the resource/pool structure 36 stores information regarding data radio resources, each of the radio resources being classified in accordance with one of plural data radio resource pool types. In an example implementation the plural data radio resource pool types include data radio resource pool Type 1 and data radio resource pool Type 2. The types are significant in that, for example, one or more Type 1 data resource pools are classified as belonging to data resource pool Type 1 and one or more Type 2 data resource pools are classified as belonging to data resource pool Type 2. The one or more Type 1 data resource pools consist of radio resources that are included in plural data resource pools and the one or more Type 2 data resource pools consist of radio resources that are included in only one of the plural Type 2 data resource pools. As such, the resource/pool structure 36 may store information that describes plural scenarios such as that represented by FIG. 4B, for example.

The data resource pool type selection controller 34 executes a pool type selection procedure in which the pool type selection controller 34 makes a pool type selection of a selected data resource pool type from which the selected radio resource is selected. For example, in the example implementation of the resource/pool structure 36 discussed above, the selected resource pool type may be either the Type 1 data resource pool type or the Type 2 data resource pool type. After the pool type is selected by data resource pool type selection controller 34, from that selected pool type the resource selection controller 35 selects a pool which belongs to that pool type, and from the selected pool then selects a selected radio resource for use in the V2X communication. In an example implementation, the V2X communication is prepared in frame generator 38, which is informed of the selected radio resource to carry the V2X communication and which receives the data for inclusion in the data radio resource from whichever of the V2X applications 44 is involved in the V2X communication.

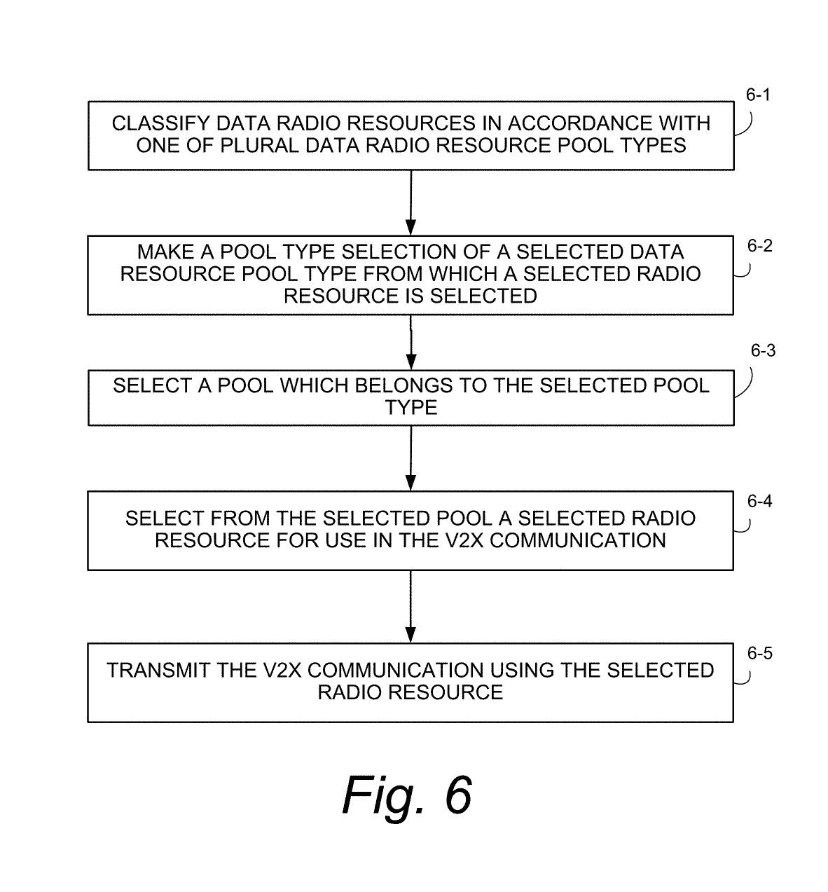

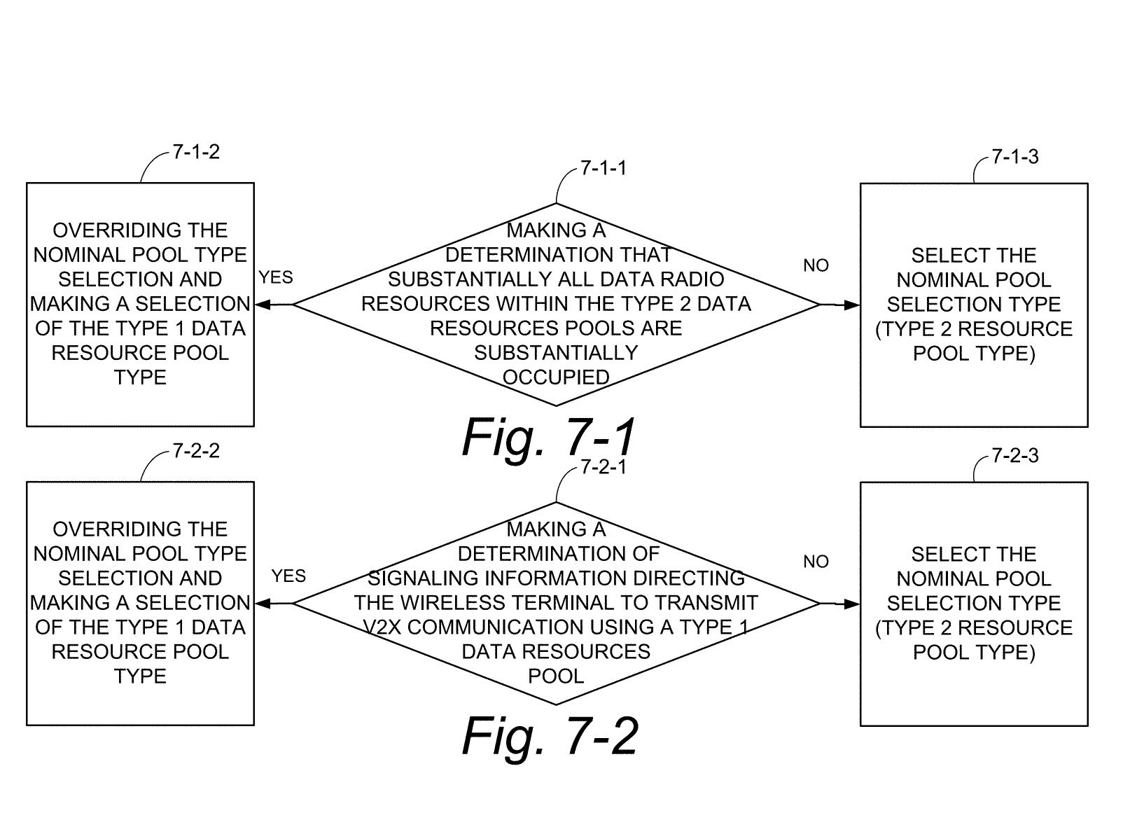

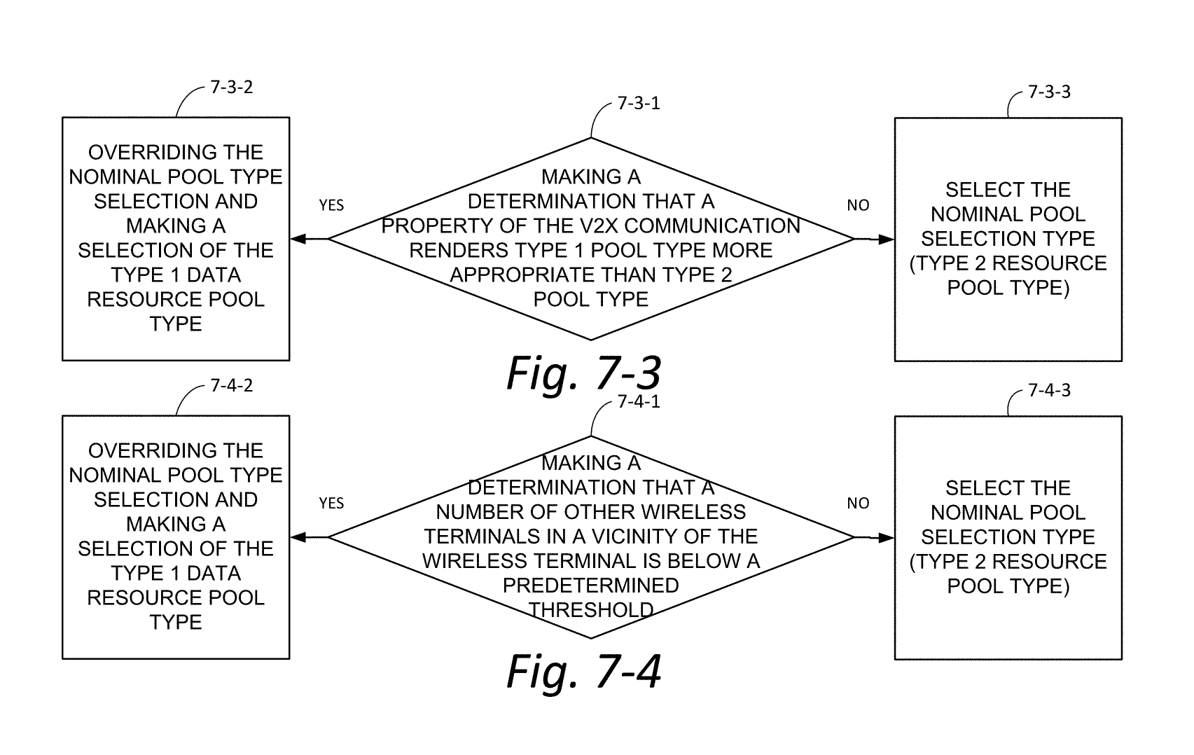

FIG. 6 illustrates basic, example acts or steps involved in a method of operating the wireless terminal 20 of FIG. 5, including acts comprising a pool type selection procedure in particular. Act 6-1 comprises classifying data radio resources in accordance with one of plural data radio resource pool types. In the example implementation described above, the plural data radio resource pool types include data radio resource pool Type 1 and data radio resource pool Type 2. Act 6-2 comprises processor circuitry, e.g., data resource pool type selection controller 34, making a pool type selection of a selected data resource pool type from which a selected radio resource is selected. In the example implementation described above, the selected resource pool type is either the Type 1 data resource pool type or the Type 2 data resource pool type.

After the pool type is selected by data resource pool type selection controller 34, as act 6-3 from that selected pool type the resource selection controller 35 selects a pool which belongs to that selected pool type. Then, as act 6-4, from the selected pool the resource selection controller 35 then selects a selected radio resource for use in the V2X communication. Act 6-5 comprising transmitting the V2X communication using the radio resource selected in act 6-4. As mentioned above, the V2X communication is prepared by frame generator 38, which is informed of the selected radio resource to carry the V2X communication and which receives the data for inclusion in the data radio resource from whichever of the V2X applications 44 is involved in the V2X communication.

Generally there are one or multiple SA pools, which means sidelink control information can follow a priority-based D2D resource selection method, or selection as described in States Patent Provisional Application 62/319,065 and U.S. patent application Ser. No. 15/477,299,entitled “RESOURCE SELECTION FOR VEHICLE (V2X) COMMUNICATIONS”. If there are multiple data pools allowed and (represented by the example scenario of FIG. 4B), the technology disclosed herein provides several alternative embodiments. In some respects there may be commonalities among the embodiments described herein, and aspects of the embodiments may be combined as desired when appropriate.

### FIRST EXAMPLE EMBODIMENT (ALTERNATIVE “A”)

In a first example embodiment (Alternative A) and a second example embodiment (Alternative B) the processor circuitry, e.g. pool type selection controller 34, makes a nominal pool type selection of a first of the one or more data radio resource pool types unless the processor circuitry determines a condition favoring a second of the one or more data radio resource pool types. As used herein, “nominal pool type selection” means selection of a conditional choice of a predetermined or initially preferred or configured pool type. However, in both the first example embodiment and the second example embodiment, if it turns out that one or more “conditions” are satisfied, then the predetermined preferred pool type, e.g., the nominal pool type, is not chosen, but instead another pool type.

In the first example embodiment, the pool type selection controller 34 makes a nominal pool type selection of the Type 2 data resource pool type, e.g., a nominal pool type selection of a “non-overlapping pool”. Unless the nominal pool type selection is overridden, when the wireless terminal has data to transmit, it always configures low layers to transmit data with Type 2 resources. But the anticipated nominal pool type selection may be overridden if controller 34 determines existence of a condition favoring the Type 1 data resource pool type.

Discussed below, as alternatives A.1 through and including A.6, are various example conditions under which, if discovered or determined by pool type selection controller 34, cause an override of the nominal pool type selection of the Type 2 data resource pool type so that the Type 1 data resource pool type is selected instead. In other words, the wireless terminal configures lower layers to transmit data within Type 1 data pools, if the following conditions are met (any combination of the following conditions, could be any one of which, or some which, or all of which):

### Alternative A.1

In Alternative A.1 the pool type selection controller 34 overrides the nominal pool type selection and makes a selection of the Type 1 data resource pool type when the processor circuitry determines that substantially all data radio resources within the Type 2 data resources pools are occupied or are about to be occupied by other wireless terminals. Stated differently, the Type 1 data resource pool type is chosen if the Type 2 data pools, which the UE can select for transmission (“can” means according to the selection criteria, the available resources for the UE; because some resources which may be reserved and available to some UEs may not necessarily be available to other UEs, e.g., higher priority resources to low priority UE transmission, or left-to-right direction resources to right-to-left direction UE transmission), are all occupied or certainly will be occupied by other wireless terminals. The resource occupation information can be obtained based on energy sensing of resources, or other wireless terminals' SA decoding, or even other wireless terminals' observation on resource selection collision of other wireless terminals, or their combinations. All these resource collision detection methods in Alternative A.1 do not have to be on all resources, but on resources within Type 2 resources firstly.

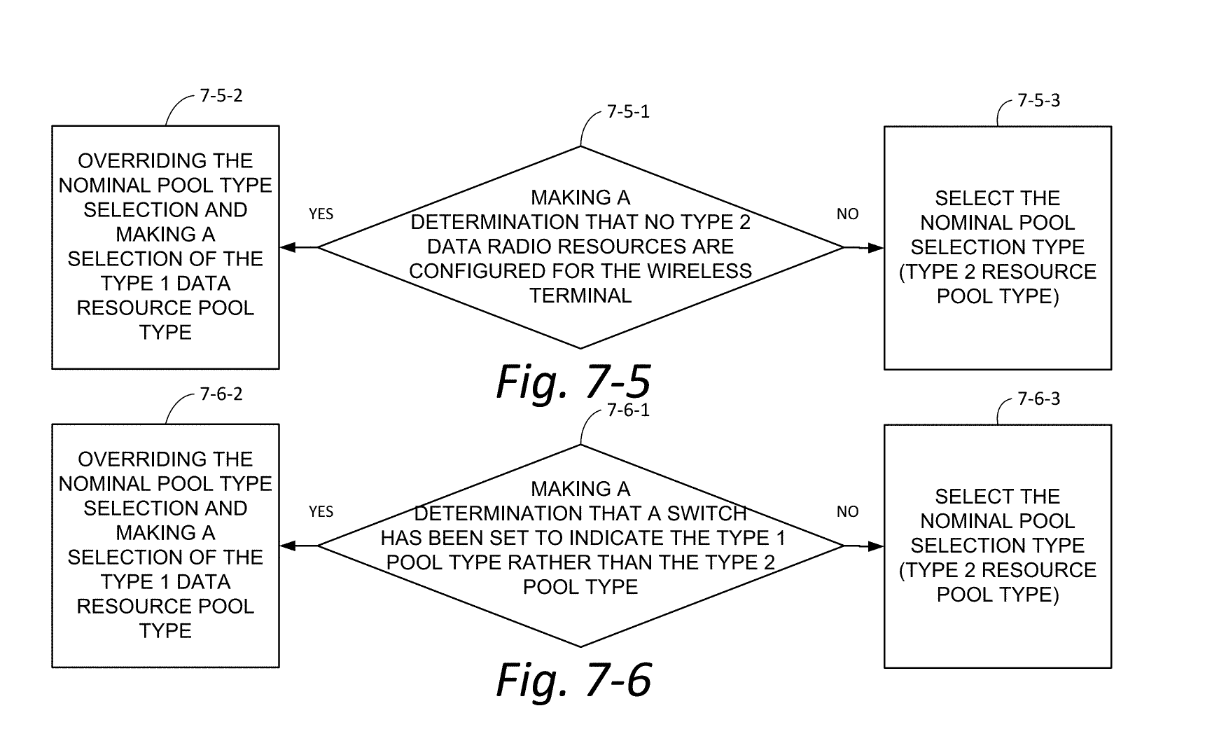

FIG. 7-1 shows example acts or steps which may be performed by pool type selection controller 34 in executing Alternative A.1. Act 7-1-1 comprises pool type selection controller 34 making a determination that substantially all data radio resources within the Type 2 data resources pools are occupied or are about to be occupied by other wireless terminals. If the determination of act 7-1-1 indicates such substantial complete occupation, act 7-1-2 is performed. Act 7-1-2 comprises overriding the nominal pool type selection and making a selection of the Type 1 data resource pool type in accordance with the determination. If the determination of act 7-1-1 is negative, e.g., if the Type 2 data resource pools are not substantially entirely occupied, as act 7-1-3 the nominal pool selection type is selected, e.g., the Type 2 pool type.

### Alternative A.2

In Alternative A.2 the pool type selection controller 34 overrides the nominal pool type selection and makes a selection of the Type 1 data resource pool type when the processor circuitry determines that the wireless terminal has received signaling information directing the wireless terminal to transmit the V2X communication using a Type 1 data resources pool. In other words, despite the nominal choice of Type 2 pool, if there is signaling information from eNB, or other wireless terminals, or a higher layer of the wireless terminal, informing or directing the wireless terminal to transmit within Type 1 data pool, then a Type 1 type pool is selected. If the signaling information is from eNB, e.g., when the eNB wants to configure a scenario with shared pools which is better for resource scheduling efficiency and system performance, or when the eNB thinks the Type 2 pools have high loads and the eNB wants to off load some resources to Type 1 pools; it applies to in coverage scenario only. If the signaling information is from other UEs, such UEs are cluster UEs or road side units (RSUs), it applies to both in coverage and out of coverage scenarios. If the signaling information is from higher layer of the UE, e.g. through system performance analysis, the core network side tells the UE to use Type 1 for transmission; it applies to both in coverage and out of coverage scenarios as well.

FIG. 7-2 shows example acts or steps which may be performed by pool type selection controller 34 in executing Alternative A.2. Act 7-2-1 comprises pool type selection controller 34 making a determination that the wireless terminal has received signaling information directing the wireless terminal to transmit the V2X communication using a Type 1 data resources pool. If the determination of act 7-2-1 indicates existence of such signaling, act 7-2-2 is performed. Act 7-2-2 comprises overriding the nominal pool type selection and making a selection of the Type 1 data resource pool type in accordance with the determination. If the determination of act 7-2-1 is negative, e.g., if signaling requiring a Type 1 pool type selection has not been received, as act 7-2-3 the nominal pool selection type is selected, e.g., the Type 2 pool type.

### Alternative A.3

In Alternative A.3 the pool type selection controller 34 overrides the nominal pool type selection and makes a selection of the Type 1 data resource pool type when the processor circuitry makes a determination that a property of the V2X communication renders the Type 1 data resource pool type more appropriate than the Type 2 data resource pool type. It will be recalled that Alternative A.1 means the wireless terminal must use Type 1 pools because all Type 2 pools are being/will be used. If the collision detection of Alternative A.1 shows that the resources are not all used, but some properties of a wireless terminal's transmission, e.g., the priority of the wireless terminal transmission, or some other property(ies)(which can be used to categorize resource pools, indicates the transmission of the wireless terminal can or has to share resources with transmissions of other wireless terminals, e.g., the priority of the transmission is low (such as lower than some priority threshold), then Alternative A.3 may be implemented. When referring to “the resources are not all used”, transmission with Type 1 resources cannot occur all the time, because the nominal transmission resources are Type 2 in this A.3 alternative. Therefore, this condition starting transmission with Type 1 resources should be limited by “The resources within Type 2 pools, which the wireless terminal can select for transmission, are occupied or certainly will be occupied by other UEs to some level, e.g., some ratio threshold (0<threshold<100%)”. Both of these two thresholds, the resource occupation threshold and the criteria, e.g., priority, threshold, are pre-configured within wireless terminal no matter whether the wireless terminal is in coverage; or broadcasted to wireless terminals, or sent to the wireless terminal in dedicated RRC signaling, when the UE is in coverage. Thus, in Alt Alternative A.3 if the Type 2 dedicated pool has too many wireless terminals, the lower priority wireless terminals should go to Type 1 shared pool, so as to generating less interference to higher priority wireless terminal.

FIG. 7-3 shows example acts or steps which may be performed by pool type selection controller 34 in executing Alternative A.3. Act 7-3-1 comprises pool type selection controller 34 making a determination that a property of the V2X communication renders the

Type 1 data resource pool type more appropriate than the Type 2 data resource pool type. If the determination of act 7-3-1 indicates existence of such a transmission property, act 7-3-2 is performed. Act 7-3-2 comprises overriding the nominal pool type selection and making a selection of the Type 1 data resource pool type in accordance with the determination. If the determination of act 7-3-1 is negative, e.g., if the transmission property does not favor a Type 1 type pool, as act 7-3-3 the nominal pool selection type is selected, e.g., the Type 2 pool type.

### Alternative A.4

In Alternative A.4 the pool type selection controller 34 overrides the nominal pool type selection and makes a selection of the Type 1 data resource pool type when the processor circuitry makes a determination that a number of other wireless terminals in a vicinity of the wireless terminal is below a predetermined threshold. In other words, if it is detected that there are small amount of wireless terminals, or no wireless terminals, nearby, then the nominal Type 2 resource pool type is overridden and the Type 1 type resource pool type chosen instead. For Alternative A.4 they may be a threshold for a number of nearby wireless terminals, similar to the threshold of Alternative A.3. The threshold and its value can be pre-configured within the wireless terminal no matter whether the wireless terminal is in coverage or out over coverage; or broadcasted to wireless terminals, or sent to wireless terminal in dedicate RRC signaling, when the wireless terminal is in coverage. The range of the wireless terminal amount threshold is ≧0. Moreover, since there is no discovery function defined for V2X communications yet, the detection of nearby wireless terminal(s) may be, for example, either through information from core network, or by measurement of S-RSRP (sidelink RSRP). Thus, in Alt A.4, if there are few enough wireless terminals, which means the wireless terminal using Type 1 shared pool would not interfere with others, the wireless terminal may go to Type 1 pool.

FIG. 7-4 shows example acts or steps which may be performed by pool type selection controller 34 in executing Alternative A.4. Act 7-4-1 comprises pool type selection controller 34 making a determination that a number of other wireless terminals in a vicinity of the wireless terminal is below a predetermined threshold. If the determination of act 7-4-1 indicates a number of other wireless terminals in a vicinity of the wireless terminal is below a predetermined threshold, act 7-4-2 is performed. Act 7-4-2 comprises overriding the nominal pool type selection and making a selection of the Type 1 data resource pool type in accordance with the determination. If the determination of act 7-4-1 is negative, e.g., if the number of other wireless terminals in a vicinity of the wireless terminal is not below the predetermined threshold, as act 7-4-3 the nominal pool selection type is selected, e.g., the Type 2 pool type.

### Alternative A.5

In Alternative A.5 the pool type selection controller 34 overrides the nominal pool type selection and makes a selection of the Type 1 data resource pool type when the processor circuitry makes a determination that no Type 2 data radio resources are configured for the wireless terminal. A situation of no Type 2 resources information configured for wireless terminal may occur when either the eNB does not broadcast the type 2 resource information to the wireless terminal, or the eNB does not send Type 2 resource information to the wireless terminal in dedicated RRC signaling, or the Type 2 resource information is not pre-configured for wireless terminal.

FIG. 7-5 shows example acts or steps which may be performed by pool type selection controller 34 in executing Alternative A.5. Act 7-5-1 comprises pool type selection controller 34 making a determination that no Type 2 data radio resources are configured for the wireless terminal. If the determination of act 7-5-1 indicates no Type 2 data radio resources are configured for the wireless terminal, act 7-5-2 is performed. Act 7-5-2 comprises overriding the nominal pool type selection and making a selection of the Type 1 data resource pool type in accordance with the determination. If the determination of act 7-5-1 is negative, that Type 2 data radio resources are configured for the wireless terminal, as act 7-4-3 the nominal pool selection type is selected, e.g., the Type 2 pool type.

### Alternative A.6

In Alternative A.6 the pool type selection controller 34 overrides the nominal pool type selection and makes a selection of the Type 1 data resource pool type when the processor circuitry makes a determination that a switch configured to select between the Type 1 data resource pool type and the Type 2 data resource pool type has been set to indicate the Type 1 data resource pool type rather than the Type 2 data resource pool type. In other words, if there is a switch for Type 1 and Type 2 resources selection, and the switch is set as “Type 2 Resource”, then the pool type selection controller 34 performs the override. The switch may be one IE (information element) carried by either eNB broadcast signaling to the wireless terminal, or obtained from eNB dedicated RRC signaling to the wireless terminal, or pre-configured for the wireless terminal.

FIG. 7-6 shows example acts or steps which may be performed by pool type selection controller 34 in executing Alternative A.6. Act 7-6-1 comprises pool type selection controller 34 making a determination that a switch configured to select between the Type 1 data resource pool type and the Type 2 data resource pool type has been set to indicate the Type 1 data resource pool type rather than the Type 2 data resource pool type. If the determination of act 7-6-1 indicates a switch has been set to indicate the Type 1 data resource pool type rather than the Type 2 data resource pool type, act 7-6-2 is performed. Act 7-6-2 comprises overriding the nominal pool type selection and making a selection of the Type 1 data resource pool type in accordance with the determination. If the determination of act 7-6-1 is negative, that the switch has been set to indicate the Type 2 data resource pool type, as act 7-4-3 the nominal pool selection type is selected, e.g., the Type 2 pool type.

As mentioned above, the transmission with Type 1 resources instead of the nominal or default Type 2 resource selection occurs when one, or any combination, of the above six conditions/alternatives are met. Even the Alternative A.1 and Alternative A.3 may not collide with each other and can form one combination of conditions: e.g., if the criteria is based on priority, then high priority transmission waits till all Type 2 resources are used to start using Type 1 resources; while low priority transmission may start using Type 1 resources when the Type 2 resources are not all used.

### SECOND EXAMPLE EMBODIMENT (ALTERNATIVE “B”)

In a second example embodiment/Alternative, the processor circuitry, e.g. pool type selection controller 34, also makes a nominal pool type selection of a first of the one or more data radio resource pool types unless the processor circuitry determines a condition favoring a second of the one or more data radio resource pool types. Like the first example embodiment, if it turns out that one or more “conditions” are satisfied, then the predetermined preferred pool type is not chosen, but instead another pool type.

In first second embodiment, the pool type selection controller 34 makes a nominal pool type selection of the Type 1 data resource pool type, e.g., a nominal pool type selection of an “overlapping pool”. Unless the nominal pool type selection is overridden, when the wireless terminal has data to transmit, it always configures low layers to transmit data with Type 1 pool type resources. But, as explained below, the anticipated nominal pool type selection may be overridden if controller 34 determines existence of a condition favoring the Type 2 data resource pool type.

Discussed below, as alternatives B.1 through and including B.6, are various example conditions under which, if discovered or determined by pool type selection controller 34, cause an override of the nominal pool type selection of the Type 1 data resource pool type so that the Type 2 data resource pool type is selected instead. In other words, the wireless terminal configures lower layers to transmit data within Type 2 data pools, if the following conditions are met (any combination of the following conditions, could be any one of which, or some which, or all of which):

### Alternative B.1

In Alternative B.1 the pool type selection controller 34 overrides the nominal pool type selection and makes a selection of the Type 2 data resource pool type when the processor circuitry determines that substantially all data radio resources within the Type 1 data resources pools are occupied or are about to be occupied by other wireless terminals. Stated differently, the Type 2 data resource pool type is chosen if the Type 1 data pools, which the UE can select for transmission (“can” means according to the selection criteria, the available resources for the UE; because some resources which may be reserved and available to some UEs may not necessarily be available to other UEs, e.g., higher priority resources to low priority UE transmission, or left-to-right direction resources to right-to-left direction UE transmission), are all occupied or certainly will be occupied by other wireless terminals. The resource occupation information can be obtained based on energy sensing of resources, or other wireless terminals' SA decoding, or even other wireless terminals' observation on resource selection collision of other wireless terminals, or their combinations. All these resource collision detection methods in Alternative B.1 do not have to be on all resources, but on resources within Type 1 resources firstly.

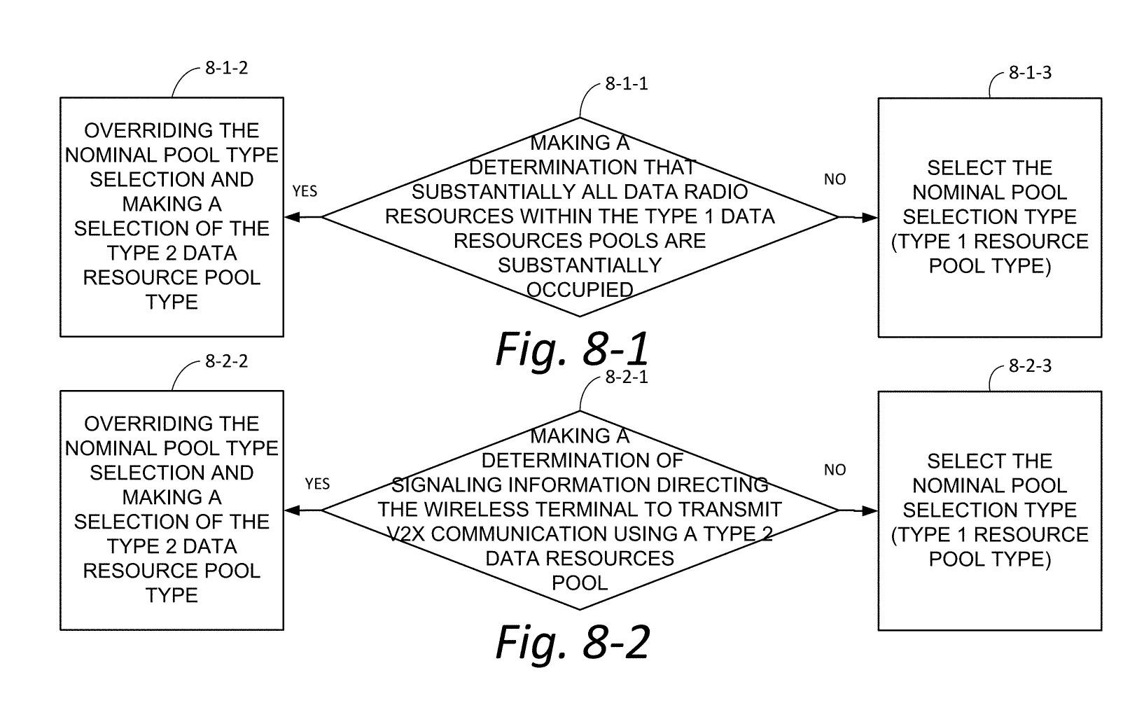

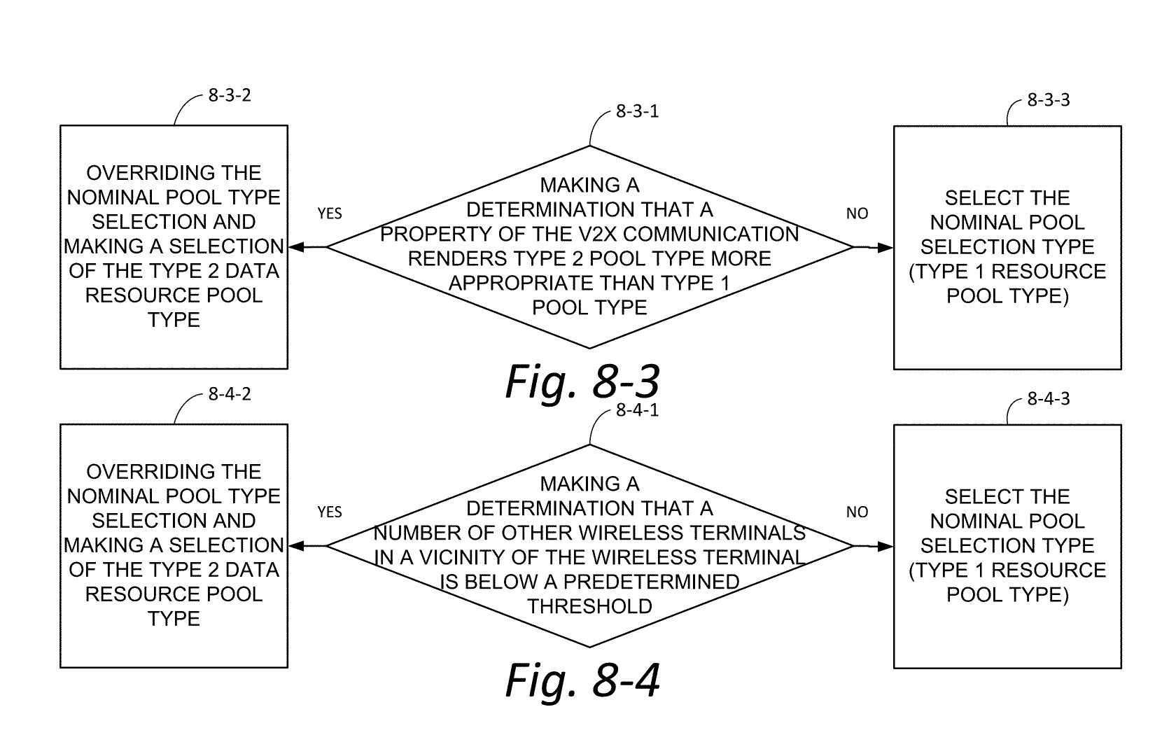

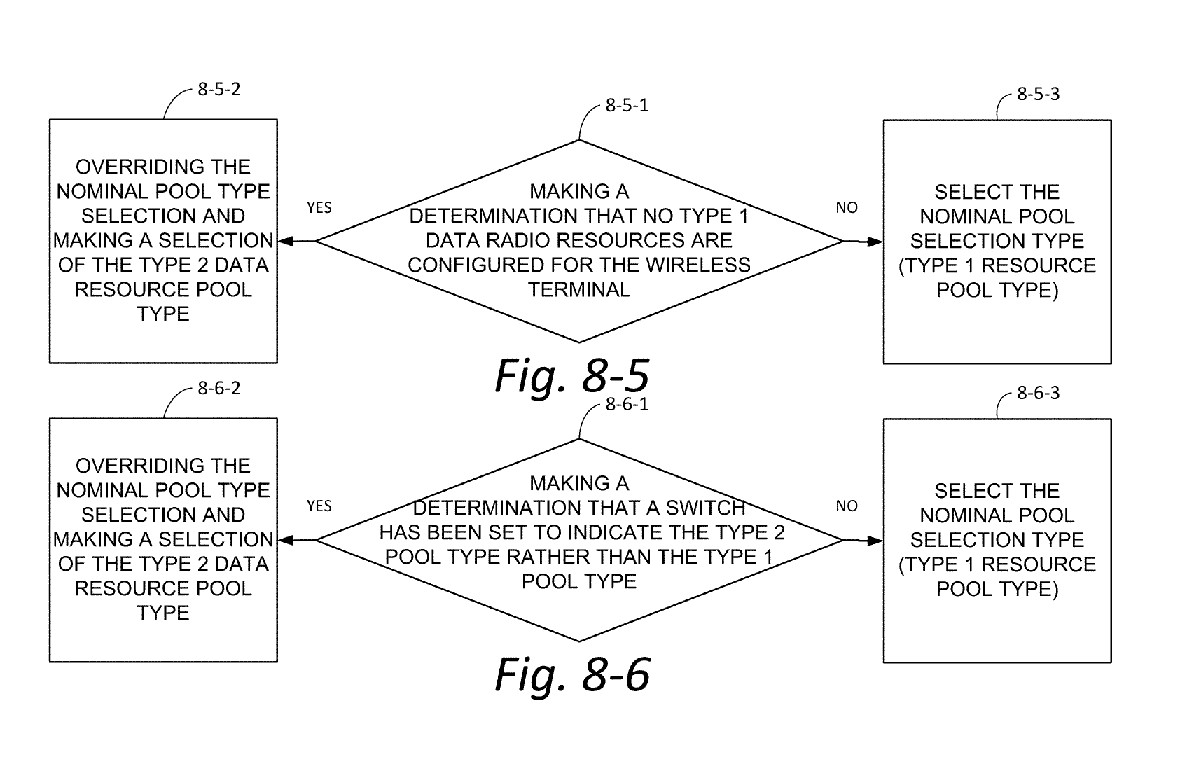

FIG. 8-1 shows example acts or steps which may be performed by pool type selection controller 34 in executing Alternative B.1. Act 8-1-1 comprises pool type selection controller 34 making a determination that substantially all data radio resources within the Type 1 data resources pools are occupied or are about to be occupied by other wireless terminals. If the determination of act 8-1-1 indicates such substantial complete occupation, act 8-1-2 is performed. Act 8-1-2 comprises overriding the nominal pool type selection and making a selection of the Type 2 data resource pool type in accordance with the determination. If the determination of act 8-1-1 is negative, e.g., if the Type 1 data resource pools are not substantially entirely occupied, as act 8-1-3 the nominal pool selection type is selected, e.g., the Type 1 pool type.

### Alternative B.2

In Alternative B.2 the pool type selection controller 34 overrides the nominal pool type selection and makes a selection of the Type 2 data resource pool type when the processor circuitry determines that the wireless terminal has received signaling information directing the wireless terminal to transmit the V2X communication using a Type 2 data resources pool. In other words, despite the nominal choice of Type 1 pool, if there is signaling information from eNB, or other wireless terminals, or a higher layer of the wireless terminal, informing or directing the wireless terminal to transmit within Type 2 data pool, then a Type 2 type pool is selected. If the signaling information is from eNB, e.g., when the eNB wants to configure a scenario with shared pools which is better for resource scheduling efficiency and system performance, or when the eNB thinks the Type 1 pools have high loads and the eNB wants to off load some resources to Type 2 pools; it applies to in coverage scenario only. If the signaling information is from other UEs, such UEs are cluster UEs or road side units (RSUs), it applies to both in coverage and out of coverage scenarios. If the signaling information is from higher layer of the UE, e.g. through system performance analysis, the core network side tells the UE to use Type 2 for transmission; it applies to both in coverage and out of coverage scenarios as well.

FIG. 8-2 shows example acts or steps which may be performed by pool type selection controller 34 in executing Alternative B.2. Act 8-2-1 comprises pool type selection controller 34 making a determination that the wireless terminal has received signaling information directing the wireless terminal to transmit the V2X communication using a Type 2 data resources pool. If the determination of act 8-2-1 indicates existence of such signaling, act 8-2-2 is performed. Act 8-2-2 comprises overriding the nominal pool type selection and making a selection of the Type 2 data resource pool type in accordance with the determination. If the determination of act 8-2-1 is negative, e.g., if signaling requiring a Type 2 pool type selection has not been received, as act 8-2-3 the nominal pool selection type is selected, e.g., the Type 1 pool type.

### Alternative B.3

In Alternative B.3 the pool type selection controller 34 overrides the nominal pool type selection and makes a selection of the Type 2 data resource pool type when the processor circuitry makes a determination that a property of the V2X communication renders the Type 2 data resource pool type more appropriate than the Type 1 data resource pool type. For example, in Alternative B.3, if Type 1 shared pool has too many wireless terminals, there will be high probability of interference among wireless terminals, in such case Alternative B.3 indicates that the higher priority wireless terminal should go to Type 2 dedicated pool to guarantee its service.

FIG. 8-3 shows example acts or steps which may be performed by pool type selection controller 34 in executing Alternative B.3. Act 8-3-1 comprises pool type selection controller 34 making a determination that a property of the V2X communication renders the Type 2 data resource pool type more appropriate than the Type 1 data resource pool type. If the determination of act 8-3-1 indicates existence of such a transmission property, act 8-3-2 is performed. Act 8-3-2 comprises overriding the nominal pool type selection and making a selection of the Type 2 data resource pool type in accordance with the determination. If the determination of act 8-3-1 is negative, e.g., if the transmission property does not favor a Type 2 type pool, as act 8-3-3 the nominal pool selection type is selected, e.g., the Type 1 pool type.

### Alternative B.4

In Alternative B.4 the pool type selection controller 34 overrides the nominal pool type selection and makes a selection of the Type 2 data resource pool type when the processor circuitry makes a determination that a number of other wireless terminals in a vicinity of the wireless terminal is above a predetermined threshold. In other words, if it is detected that there are large amount of wireless terminals nearby, then the nominal Type 1 resource pool type is overridden and the Type 2 type resource pool type chosen instead. Alt B.4, if there are a large number of wireless terminals, which means the wireless terminal using Type 1 shared pool will interfere with other UEs nearby, then the nominal Type 1 resource pool type is overridden and the Type 2 type resource pool type chosen instead.

The threshold and its value can be pre-configured within the wireless terminal no matter whether the wireless terminal is in coverage or out over coverage; or broadcasted to wireless terminals, or sent to wireless terminal in dedicate RRC signaling, when the wireless terminal is in coverage. The range of the wireless terminal amount threshold is ≧0. Moreover, since there is no discovery function defined for V2X communications yet, the detection of nearby wireless terminal(s) may be, for example, either through information from core network, or by measurement of S-RSRP (sidelink RSRP).

FIG. 8-4 shows example acts or steps which may be performed by pool type selection controller 34 in executing Alternative B.4. Act 8-4-1 comprises pool type selection controller 34 making a determination that a number of other wireless terminals in a vicinity of the wireless terminal is below a predetermined threshold. If the determination of act 8-4-1 indicates a number of other wireless terminals in a vicinity of the wireless terminal is below a predetermined threshold, act 8-4-2 is performed. Act 8-4-2 comprises overriding the nominal pool type selection and making a selection of the Type 2 data resource pool type in accordance with the determination. If the determination of act 8-4-1 is negative, e.g., if the number of other wireless terminals in a vicinity of the wireless terminal is not below the predetermined threshold, as act 8-4-3 the nominal pool selection type is selected, e.g., the Type 1 pool type.

### Alternative B.5

In Alternative B.5 the pool type selection controller 34 overrides the nominal pool type selection and makes a selection of the Type 2 data resource pool type when the processor circuitry makes a determination that no Type 1 data radio resources are configured for the wireless terminal. A situation of no Type 1 resources information configured for wireless terminal may occur when either the eNB does not broadcast the type 1 resource information to the wireless terminal, or the eNB does not send Type 1 resource information to the wireless terminal in dedicated RRC signaling, or the Type 1 resource information is not pre-configured for wireless terminal.

FIG. 8-5 shows example acts or steps which may be performed by pool type selection controller 34 in executing Alternative B.5. Act 8-5-1 comprises pool type selection controller 34 making a determination that no Type 1 data radio resources are configured for the wireless terminal. If the determination of act 8-5-1 indicates no Type 1 data radio resources are configured for the wireless terminal, act 8-5-2 is performed. Act 8-5-2 comprises overriding the nominal pool type selection and making a selection of the Type 2 data resource pool type in accordance with the determination. If the determination of act 8-5-1 is negative, that Type 1 data radio resources are configured for the wireless terminal, as act 8-4-3 the nominal pool selection type is selected, e.g., the Type 1 pool type.

### Alternative B.6

In Alternative B.6 the pool type selection controller 34 overrides the nominal pool type selection and makes a selection of the Type 2 data resource pool type when the processor circuitry makes a determination that a switch configured to select between the Type 2 data resource pool type and the Type 1 data resource pool type has been set to indicate the Type 2 data resource pool type rather than the Type 1 data resource pool type. In other words, if there is a switch for Type 2 and Type 1 resources selection, and the switch is set as “Type 1 Resource”, then the pool type selection controller 34 performs the override. The switch may be one IE (information element) carried by either eNB broadcast signaling to the wireless terminal, or obtained from eNB dedicated RRC signaling to the wireless terminal, or pre-configured for the wireless terminal.

FIG. 8-6 shows example acts or steps which may be performed by pool type selection controller 34 in executing Alternative B.6. Act 8-6-1 comprises pool type selection controller 34 making a determination that a switch configured to select between the Type 2 data resource pool type and the Type 1 data resource pool type has been set to indicate the Type 2 data resource pool type rather than the Type 1 data resource pool type. If the determination of act 8-6-1 indicates a switch has been set to indicate the Type 2 data resource pool type rather than the Type 1 data resource pool type, act 8-6-2 is performed. Act 8-6-2 comprises overriding the nominal pool type selection and making a selection of the Type 2 data resource pool type in accordance with the determination. If the determination of act 8-6-1 is negative, that the switch has been set to indicate the Type 1 data resource pool type, as act 8-4-3 the nominal pool selection type is selected, e.g., the Type 1 pool type.

As mentioned above, the transmission with Type 2 resources instead of the nominal or default Type 1 resource selection occurs when one, or any combination, of the above six conditions/alternatives are met. Even the Alternative B.1 and Alternative B.3 may not collide with each other and can form one combination of conditions: e.g., if the criteria is based on priority, then high priority transmission waits till all Type 1 resources are used before using Type 2 resources; while low priority transmission may start using Type 2 resources when the Type 1 resources are not all used.

### THIRD EXAMPLE EMBODIMENT (ALTERNATIVE “C”)

It has been mentioned above that in the first example embodiment (Alternative A) and the second example embodiment (Alternative B) the processor circuitry, e.g. pool type selection controller 34, makes a nominal pool type selection of a first of the one or more data radio resource pool types unless the processor circuitry determines a condition favoring a second of the one or more data radio resource pool types. In a third example embodiment no such nominal pool type selection is made, but rather the pool type selection controller 34 directly chooses a pool type (e.g., either Type 1 resource pool type or Type 1 resource pool type based on determination of conditions.

Discussed below, as alternatives C.1 through and including C.6, are various example conditions under which directly affect choice of data resource pool type. It should be understood that any one or more of the conditions described in alternatives C.1 through C.6 may be implemented, either alone or in combination.

### Alternative C.1

According to Alternative C.1, the pool type selection controller 34 makes a pool type selection of the selected data resource pool type on the basis of substantial non-availability of one of the data resource pool types.

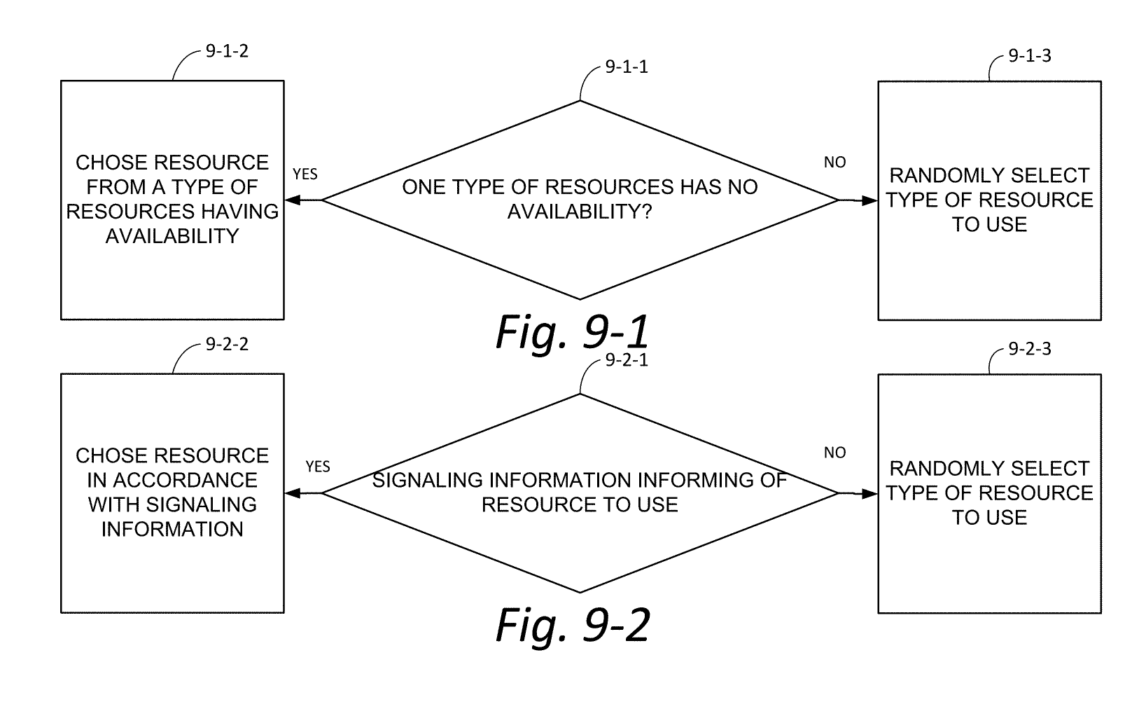

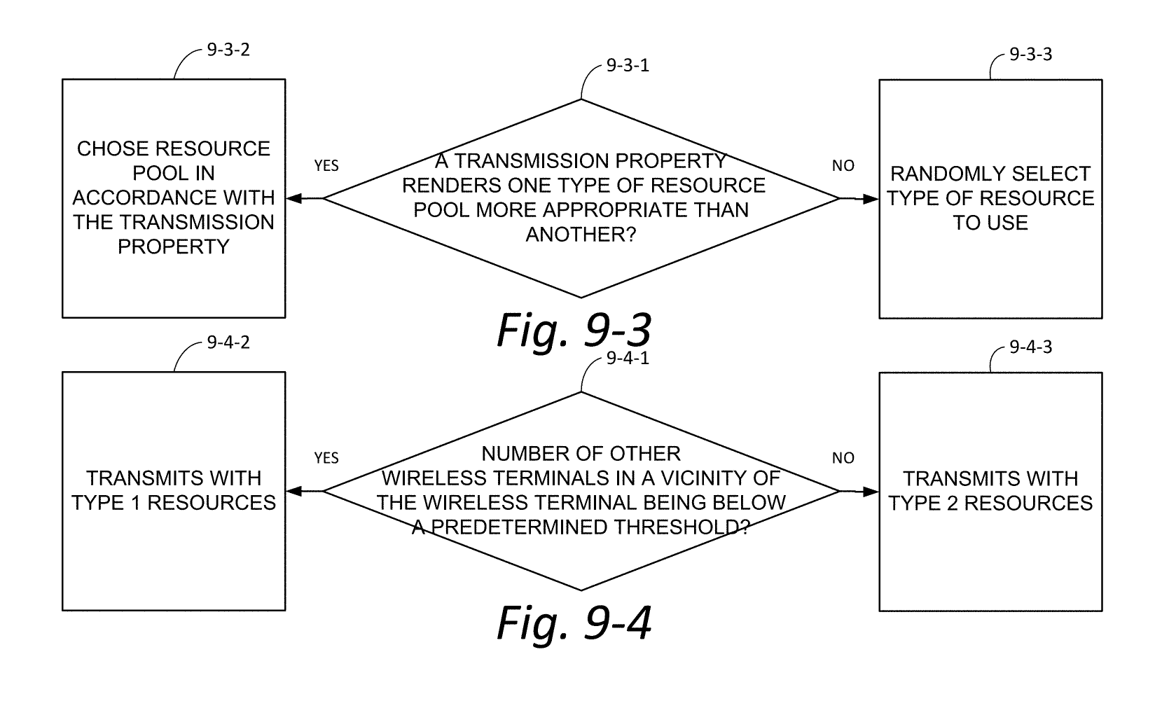

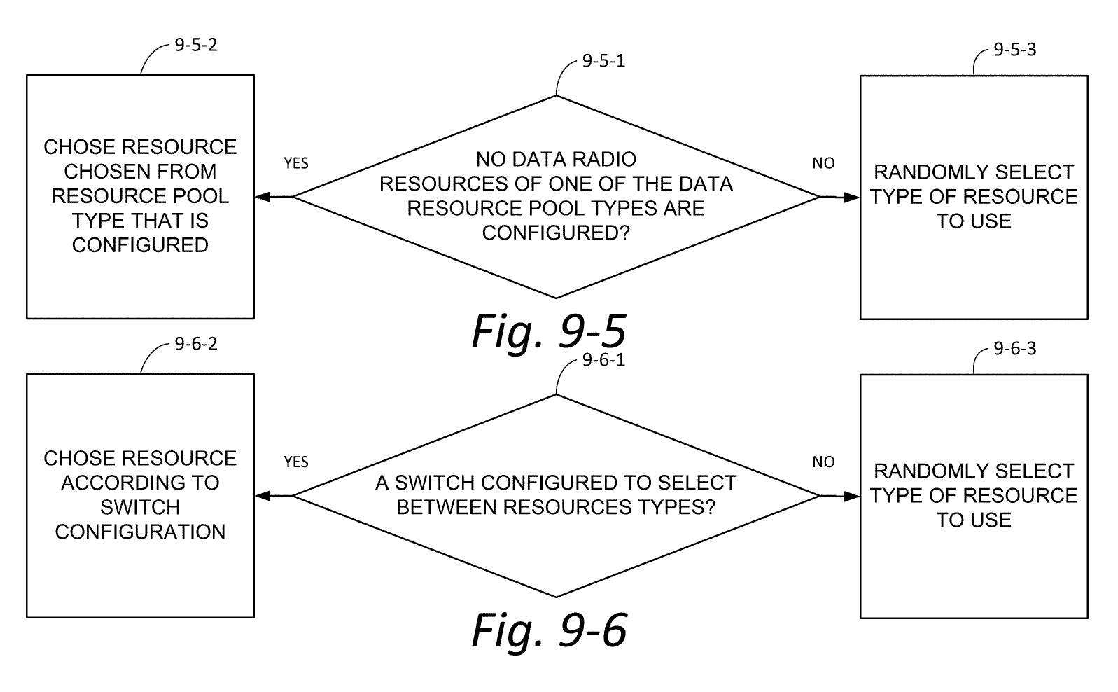

In other words, the pool type selection depends on whether the Type 1 or Type 2 resources, which the UE can select for transmission, are all occupied or certainly will be occupied by other wireless terminals. For Alternative C.1 the resource selection collision detection focuses on each type of resources. If one type of resources has no availability, the UE uses the other type of resources. FIG. 9-1 shows as act 9-1-1 the wireless terminal making a determination whether one type of resources has no availability. If the determination of act 9-1-1 is affirmative (one type of resources does not have availability), as act 9-1-2 a resource is chosen from a type of resources having availability. If the determination of act 9-1-1 is negative, as act 9-1-3 the type of resource to use is randomly selected.

### Alternative C.2

According to Alternative C.2, the pool type selection controller 34 makes a pool type selection of the selected data resource pool type on the basis of signaling information directing the wireless terminal to transmit the V2X communication using of one of the data resource pool types. In other words, if there is signaling information from eNB, or other UEs, or higher layer of the UE, informing the UE to transmit within which kind of pool (Type 1 or Type 2) to use, then the signaling type of resource is used. FIG. 9-2 shows as act 9-2-1 the wireless terminal making a determination whether there is signaling information informing of resource to use. If the determination of act 9-2-1 is affirmative (e.g., there is signaling information), as act 9-2-2 a resource is chosen in accordance with signaling information. If the determination of act 9-2-1 is negative, as act 9-2-3 the type of resource to use is randomly selected.

### Alternative C.3

According to Alternative C.3, the pool type selection controller 34 makes a pool type selection of the selected data resource pool type on the basis of a property of the V2X communication that renders one data resource pool type more appropriate than the other data resource pool type. Whether one type of resources, which the UE can select for transmission, are occupied or certainly will be occupied by other UEs to some level, e.g., some ratio threshold (0<threshold<100%), and some properties of the wireless terminal's transmission, e.g., its priority, or some other property(ies) which can be used to categorize resource pools, indicates the transmission of the wireless terminal can or has to use the other type of resources. FIG. 9-3 shows as act 9-3-1 the wireless terminal making a determination a transmission property renders one type of resource pool more appropriate than another. If the determination of act 9-3-1 is affirmative (e.g., there is an applicable property), as act 9-3-2 a resource is chosen in accordance with the transmission property. If the determination of act 9-3-1 is negative, as act 9-3-3 the type of resource to use is randomly selected.

### Alternative C.4

According to Alternative C.4, the pool type selection controller 34 makes a pool type selection of the selected data resource pool type on the basis of a number of other wireless terminals in a vicinity of the wireless terminal being below a predetermined threshold. If there are few enough nearby wireless terminals (lower bound number threshold), then it means the wireless terminal is also far from other wireless terminals, the wireless terminal transmits with Type 1 resources without generating interference to other wireless terminals. But If there are a sufficient number of nearby wireless terminals (higher bound number threshold), then it means the wireless terminal may generate interference to other wireless terminals if using shared resources, in which case the wireless terminal transmits with Type 2 resources. The higher bound number threshold≧lower bound number threshold. FIG. 9-4 shows as act 9-4-1 the wireless terminal making a determination that number of other wireless terminals in a vicinity of the wireless terminal being below a predetermined threshold. If the determination of act 9-4-1 is affirmative, as act 9-4-2 the wireless terminal transmits with Type 1 resources. If the determination of act 9-4-1 is negative, as act 9-4-3 wireless terminal transmits with Type 2 resources.

### Alternative C.5

According to Alternative C.5, the pool type selection controller 34 makes a pool type selection of the selected data resource pool type on the basis of a determination that no data radio resources of one of the data resource pool types are configured for the wireless terminal. In other words, the Alternative C.5 determination is a determination whether Type 1 resources information or Type 2 resources information are/are not configured for the wireless terminal. FIG. 9-5 shows as act 9-5-1 the wireless terminal making a determination that no data radio resources of one of the data resource pool types are configured. If the determination of act 9-5-1 is affirmative, as act 9-5-2 a resource is chosen from resource pool type that is configured. If the determination of act 9-5-1 is negative, as act 9-5-3 the type of resource to use is randomly selected.

### Alternative C.6

According to Alternative C.6, the pool type selection controller 34 makes a pool type selection of the selected data resource pool type on the basis of a switch configured to select between the Type 1 data resource pool type and the Type 2 data resource pool type. In other words, the determination of Alternative C.6 comprising whether a switch has been set for Type 1 or Type 2 resources. FIG. 9-6 shows as act 9-6-1 the wireless terminal making a determination that a switch configured to select between resources types. If the determination of act 9-6-1 is affirmative (e.g., a switch is configured), as act 9-6-2 a resource is chosen according to switch configuration. If the determination of act 9-6-1 is negative, as act 9-6-3 the type of resource to use is randomly selected.

If none of the above conditions of Alternative C.1 through Alternative C.6 are met, for example, in Alt C.4, the lower bound number threshold and higher bound number threshold are not the same value, then the UE may randomly select resources between Type 1 or Type 2 for transmission of the V2X communication.

Mention has been made above regarding “resource pool information configured for the wireless terminal” or for the UE or the like. As mentioned above, the pool information may be broadcasted to the wireless terminal, or RRC-signaled to the wireless terminal, or pre-configured for the wireless terminal. Regardless of how conveyed, the resource pool information of Type 1, Type 2 and even Type 3 may be expressed in any suitable form to the wireless terminal so that the wireless terminal can determine which resource pool (resource sets in terms of time and frequency resources) it will use. Alternatives D.1 through D.4 below provide example ways of expressing the pool information, e.g., information regarding data radio resources.

Alternative D.1>“Type 1 pool list” and “Type 2 pool list” for UE use

Alternative D.2>“Type 1 pool list” and “Type 3 pool list” for UE use, so the UE can implicitly know what the Type 2 pools are

Alternative D.3>“Type 2 pool list” and “Type 3 pool list” for UE use, so the UE can implicitly know what the Type 1 pools are

Alternative D.4>All “Type 1 pool list” “Type 2 pool list” and “Type 3 pool list” for UE use.

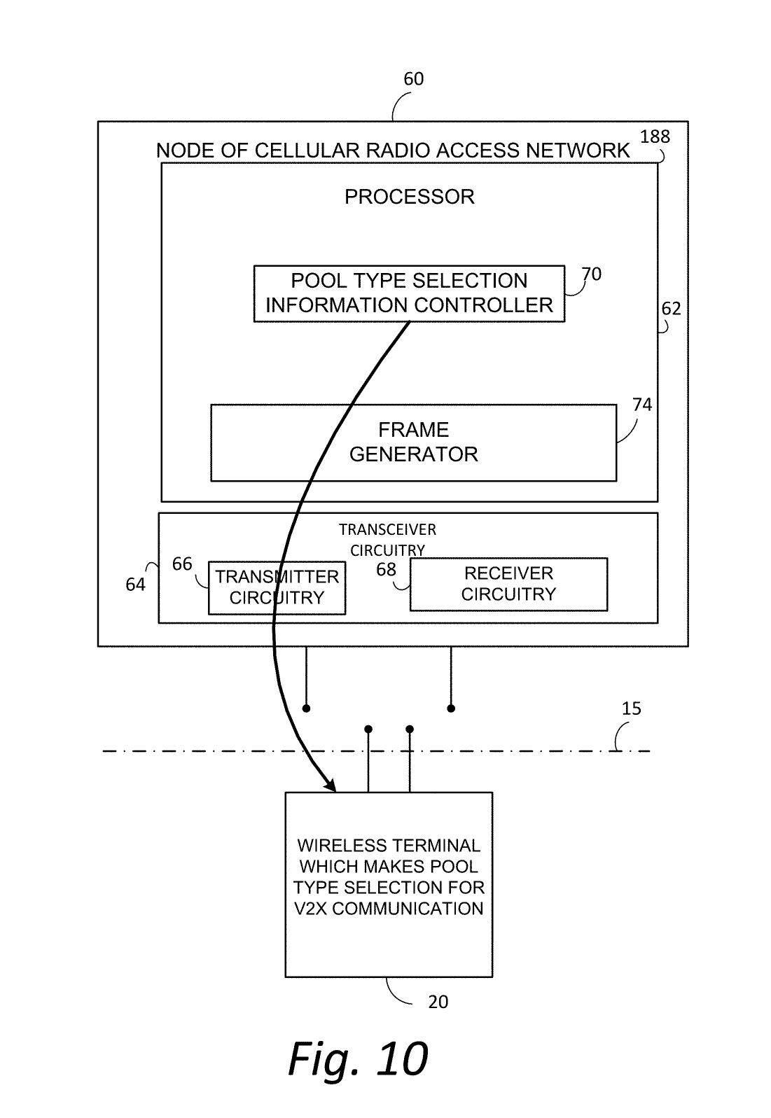

FIG. 10 illustrates node 60 of a cellular radio access network which facilitates implementation of pool type selection by a wireless terminal for vehicle (V2X) communications. The node 60 may be a base station node, such as an eNodeB (e.g., eNB) for example, or another wireless terminal. The node 60 comprises processor circuitry 62 and transceiver circuitry 64. The transceiver circuitry 64 in turn comprises transmitter circuitry 66 and receiver circuitry 68. The processor circuitry 62 comprises pool type selection information controller 70 and frame generator 74.

The pool type selection information controller 70 provides pool type selection information to wireless terminal 20, the wireless terminal being configured to participate in a vehicle (V2X) communication. In an example embodiment and mode the pool type selection information comprises criteria to facilitate selection by the wireless terminal between data radio resource pool Type 1 and data radio resource pool Type 2 as a selected data resource pool from which the wireless terminal selects a radio resource for the V2X communication. As mentioned above, one or more Type 1 data resource pools is classified as belonging to data resource pool Type 1 and one or more Type 2 data resource pools is classified as belonging to data resource pool Type 2. The one or more Type 1 data resource pools consist of radio resources that are included in plural data resource pools and the one or more Type 2 data resource pools consist of radio resources that are included in only one of the plural Type 2 data resource pools.

In one example embodiment and mode the transmitter 66 is configured to transmit the pool type selection criteria information to the wireless terminal in a broadcast message. In another example embodiment and mode the transmitter 66 is configured to transmit the pool type selection criteria information to the wireless terminal in a radio resource control (RRC) message.

In another example embodiment and mode the pool type selection information is configured to direct the wireless terminal to transmit the V2X communication using of one of the data resource pool types.1.

In another example embodiment and mode the pool type selection information is configured as a switch, or configured to set a switch, the switch being used by the wireless terminal to select between the Type 1 data resource pool type and the Type 2 data resource pool type.

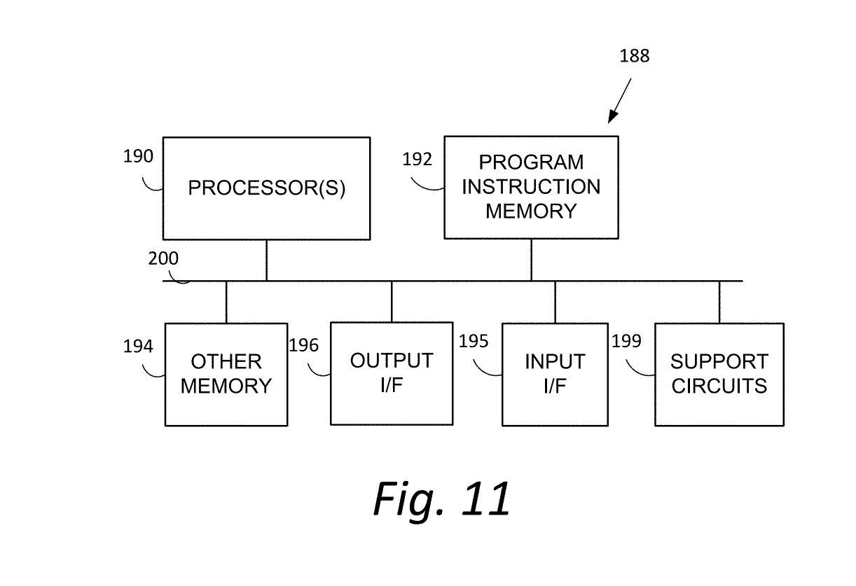

Certain units and functionalities of wireless terminal 20 may be implemented by terminal electronic machinery 88. FIG. 11 shows an example of such electronic machinery 188 as comprising one or more processors 190, program instruction memory 192; other memory 194 (e.g., RAM, cache, etc.); input interfaces 195; output interfaces 196; peripheral interfaces 198; support circuits 199; and busses 200 for communication between the aforementioned units. The processor(s) 190 may comprise the processor circuitries described herein, for example.

The memory 194, or computer-readable medium, may be one or more of readily available memory such as random access memory (RAM), read only memory (ROM), floppy disk, hard disk, flash memory or any other form of digital storage, local or remote, and is preferably of non-volatile nature, as and such may comprise memory 40 shown in FIG. 5 or memory 140 shown in FIG. 10. The support circuits 199 are coupled to the processors 190 for supporting the processor in a conventional manner. These circuits include cache, power supplies, clock circuits, input/output circuitry and subsystems, and the like.

Although the processes and methods of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routines of the disclosed embodiments are capable of being executed on any computer operating system, and is capable of being performed using any CPU architecture.

The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented, and thus machine-implemented.

In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and/or field programmable gate array(s) (FPGA(s)), and (where appropriate) state machines capable of performing such functions.

In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” may also be construed to refer to other hardware capable of performing such functions and/or executing software, such as the example hardware recited above.

Nodes that communicate using the air interface also have suitable radio communications circuitry. Moreover, the technology disclosed herein may additionally be considered to be embodied entirely within any form of computer-readable memory, such as solid-state memory, magnetic disk, or optical disk containing an appropriate set of computer instructions that would cause a processor to carry out the techniques described herein.

Moreover, each functional block or various features of the wireless terminal 40 used in each of the aforementioned embodiments may be implemented or executed by circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller or a state machine. The general-purpose processor or each circuit described above may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

It will be appreciated that the technology disclosed herein is directed to solving radio communications-centric issues and is necessarily rooted in computer technology and overcomes problems specifically arising in radio communications. Moreover, the technology disclosed herein improves basic function of a wireless terminal and a base station, so that, for example, operation of these entities may occur more effectively by prudent use of radio resources.

Embodiments and Modes of the technology disclosed herein thus include the following as non-exhaustive and non-limiting examples:

In one of its aspects the technology disclosed herein concerns a wireless terminal configured for use in vehicle (V2X) communications comprising a transmitter, a memory, and processor circuitry. The transmitter is configured to send a V2X communication using a selected radio resource. The memory is configured to store information regarding data radio resources which belong to an overlapping data radio resource pool and data radio resources which belong to a non-overlapping data radio resource pool. The processor circuitry is configured to make selection of the selected radio resource from among the overlapping data radio resource pool and the non-overlapping data radio resource pool.

In an example embodiment and mode the memory is configured to store information regarding the data radio resources each of which are classified in accordance with one of plural data radio resource pool types including data radio resource pool Type 1 and data radio resource pool Type 2. One or more Type 1 data resource pools are classified as belonging to data resource pool Type 1 and one or more Type 2 data resource pools are classified as belonging to data resource pool Type 2. The one or more Type 1 data resource pools consist of radio resources that are included in plural data resource pools and the one or more Type 2 data resource pools consist of radio resources that are included in only one of the plural Type 2 data resource pools. The processor circuitry is configured to make a pool type selection of a selected data resource pool type from which the selected radio resource is selected; the selected resource pool type being either the Type 1 data resource pool type or the Type 2 data resource pool type.

In an example embodiment and mode the processor circuitry is configured to make a nominal pool type selection of a first of the one or more data radio resource pool types unless the processor circuitry determines a condition favoring a second of the one or more data radio resource pool types.

In an example embodiment and mode the processor circuitry is configured to make a nominal pool type selection of the Type 2 data resource pool type.

In an example embodiment and mode the processor circuitry is configured to override the nominal pool type selection and to make a selection of the Type 1 data resource pool type when the processor circuitry determines that substantially all data radio resources within the Type 2 data resources pools are occupied or are about to be occupied by other wireless terminals.

In an example embodiment and mode processor circuitry is configured to override the nominal pool type selection and make a selection of the Type 1 data resource pool type when the processor circuitry determines that the wireless terminal has received signaling information directing the wireless terminal to transmit the V2X communication using a Type 1 data resources pool.

In an example embodiment and mode the processor circuitry is configured to override the nominal pool type selection and make a selection of the Type 1 data resource pool type when the processor circuitry determines that a property of the V2X communication renders the Type 1 data resource pool type more appropriate than the Type 2 data resource pool type.

In an example embodiment and mode the processor circuitry is configured to override the nominal pool type selection and make a selection of the Type 1 data resource pool type when the processor circuitry determines that a number of other wireless terminals in a vicinity of the wireless terminal is below a predetermined threshold.

In an example embodiment and mode the processor circuitry is configured to override the nominal pool type selection and make a selection of the Type 1 data resource pool type when the processor circuitry determines that no Type 2 data radio resources are configured for the wireless terminal.

In an example embodiment and mode the processor circuitry is configured to override the nominal pool type selection and make a selection of the Type 1 data resource pool type when the processor circuitry determines that a switch configured to select between the Type 1 data resource pool type and the Type 2 data resource pool type has been set to indicate the Type 1 data resource pool type rather than the Type 2 data resource pool type.

In an example embodiment and mode the processor circuitry is configured to make the nominal pool type selection of the Type 1 data resource pool type.

In an example embodiment and mode the processor circuitry is configured to override the nominal pool type selection and make a selection of the Type 2 data resource pool type when the processor circuitry determines that substantially all data radio resources within the Type 1 data resources pools are occupied or are about to be occupied by other wireless terminals.

In an example embodiment and mode the processor circuitry is configured to override the nominal pool type selection and make a selection of the Type 2 data resource pool type when the processor circuitry determines that the wireless terminal has received signaling information directing the wireless terminal to transmit the V2X communication using a Type 2 data resources pool.

In an example embodiment and mode the processor circuitry is configured to override the nominal pool type selection and make a selection of the Type 2 data resource pool type when the processor circuitry determines that a property of the V2X communication renders the Type 2 data resource pool type more appropriate than the Type 1 data resource pool type.

In an example embodiment and mode the processor circuitry is configured to override the nominal pool type selection and make a selection of the Type 2 data resource pool type when the processor circuitry determines that a number of other wireless terminals in a vicinity of the wireless terminal is below a predetermined threshold.

In an example embodiment and mode the processor circuitry is configured to override the nominal pool type selection and make a selection of the Type 2 data resource pool type when the processor circuitry determines that no Type 1 data radio resources are configured for the wireless terminal.

In an example embodiment and mode the processor circuitry is configured to override the nominal pool type selection and make a selection of the Type 2 data resource pool type when the processor circuitry determines that a switch configured to select between the Type 1 data resource pool type and the Type 2 data resource pool type has been set to indicate the Type 2 data resource pool type rather than the Type 2 data resource pool type.

In an example embodiment and mode the processor circuitry is configured to make the pool type selection of the selected data resource pool type on the basis of substantial non-availability of one of the data resource pool types.

In an example embodiment and mode the processor circuitry is configured to make the pool type selection of the selected data resource pool type on the basis of signaling information directing the wireless terminal to transmit the V2X communication using of one of the data resource pool types.

In an example embodiment and mode the processor circuitry is configured to make the pool type selection of the selected data resource pool type on the basis of a property of the V2X communication that renders one data resource pool type more appropriate than the other data resource pool type.

In an example embodiment and mode the processor circuitry is configured to make the pool type selection of the selected data resource pool type on the basis of a number of other wireless terminals in a vicinity of the wireless terminal being below a predetermined threshold.

In an example embodiment and mode the processor circuitry is configured to make the pool type selection of the selected data resource pool type on the basis of a determination that no data radio resources of one of the data resource pool types are configured for the wireless terminal.

In an example embodiment and mode the processor circuitry is configured to make the pool type selection of the selected data resource pool type on the basis of a switch configured to select between the Type 1 data resource pool type and the Type 2 data resource pool type.

In an example embodiment and mode the wireless terminal further comprises a receiver, and wherein the information regarding the one or more Type 1 data resource pools and the one or more Type 2 data resource pools is obtained over a radio interface by the receiver in (1) a broadcast message, or (2) radio resource control (RRC) signaling.

In an example embodiment and mode the wireless terminal further comprises a receiver, and wherein the information regarding the one or more Type 1 data resource pools and the one or more Type 2 data resource pools is configured in the memory of the wireless terminal.

In another of its aspects the technology disclosed herein concerns a method of operating a wireless terminal configured for use in vehicle (V2X) communications. In a basic mode the method comprises: classifying data radio resources as belonging to one of an overlapping data radio resource pools and a non-overlapping data radio resource pool; using processor circuitry to make selection of a selected radio resource from among the overlapping data radio resource pools and the non-overlapping data radio resource pool; and, transmitting a V2X communication using the selected radio resource.

In an example embodiment and mode classifying the data radio resources as belonging to one of the overlapping data radio resource pools and the non-overlapping data radio resource pool comprises classifying the data radio resources in accordance with one of plural data radio resource pool types including data radio resource pool

Type 1 and data radio resource pool Type 2, one or more Type 1 data resource pools being classified as belonging to data resource pool Type 1 and one or more Type 2 data resource pools being classified as belonging to data resource pool Type 2, the one or more Type 1 data resource pools consisting of radio resources that are included in plural data resource pools and 2 0 the one or more Type 2 data resource pools consisting of radio resources that are included in only one of the plural Type 2 data resource pools; and further comprises using the processor circuitry to make a pool type selection of a selected data resource pool type from which a selected radio resource is selected; the selected resource pool type being either the Type 1 data resource pool type or the Type 2 data resource pool type.

In an example embodiment and mode the method further comprises the processor circuitry making a nominal pool type selection of a first of the one or more data radio resource pool types unless the processor circuitry determines a condition favoring a second of the one or more data radio resource pool types.

In an example embodiment and mode the method further comprises the processor circuitry making a nominal pool type selection of the Type 2 data resource pool type.

In an example embodiment and mode the method further comprises the processor circuitry: making a determination that substantially all data radio resources within the Type 2 data resources pools are occupied or are about to be occupied by other wireless terminals; and overriding the nominal pool type selection and making a selection of the Type 1 data resource pool type in accordance with the determination.

In an example embodiment and mode the method further comprises the processor circuitry: making a determination that the wireless terminal has received signaling information directing the wireless terminal to transmit the V2X communication using a Type 1 data resources pool; overriding the nominal pool type selection and making a selection of the Type 1 data resource pool type in accordance with the determination.

In an example embodiment and mode the method further comprises the processor circuitry: making a determination that a property of the V2X communication renders the Type 1 data resource pool type more appropriate than the Type 2 data resource pool type; and overriding the nominal pool type selection and making a selection of the Type 1 data resource pool type in accordance with the determination.

In an example embodiment and mode the method further comprises the processor circuitry: making a determination that a number of other wireless terminals in a vicinity of the wireless terminal is below a predetermined threshold; and overriding the nominal pool type selection and making a selection of the Type 1 data resource pool type in accordance with the determination.

In an example embodiment and mode the method further comprises the processor circuitry: making a determination that no Type 2 data radio resources are configured for the wireless terminal; and overriding the nominal pool type selection and making a selection of the Type 1 data resource pool type in accordance with the determination.

In an example embodiment and mode the method further comprises the processor circuitry: making a determination that a switch configured to select between the Type 1 data resource pool type and the Type 2 data resource pool type has been set to indicate the Type 1 data resource pool type rather than the Type 2 data resource pool type; and overriding the nominal pool type selection and making a selection of the Type 1 data resource pool type in accordance with the determination.

In an example embodiment and mode the method further comprises the processor circuitry making the nominal pool type selection of the Type 1 data resource pool type.

In an example embodiment and mode the method further comprises the processor circuitry: making a determination that substantially all data radio resources within the Type 1 data resources pools are occupied or are about to be occupied by other wireless terminals; overriding the nominal pool type selection and making a selection of the Type 2 data resource pool type in accordance with determination.

In an example embodiment and mode the method further comprises the processor circuitry: making a determination that the wireless terminal has received signaling information directing the wireless terminal to transmit the V2X communication using a Type 2 data resources pool; and overriding the nominal pool type selection and making a selection of the Type 2 data resource pool type in accordance with the determination.2.

In an example embodiment and mode the method further comprises the processor circuitry: making a determination that a property of the V2X communication renders the Type 2 data resource pool type more appropriate than the Type 1 data resource pool type; overriding the nominal pool type selection and making a selection of the Type 2 data resource pool type in accordance with the determination.

In an example embodiment and mode the method further comprises the processor circuitry: making a determination that a number of other wireless terminals in a vicinity of the wireless terminal is below a predetermined threshold; overriding the nominal pool type selection and making a selection of the Type 2 data resource pool type in accordance with the determination.

In an example embodiment and mode the method further comprises the processor circuitry: making a determination that no Type 1 data radio resources are configured for the wireless terminal; overriding the nominal pool type selection and making a selection of the Type 2 data resource pool type in accordance with the determination.

In an example embodiment and mode the method further comprises the processor circuitry: making a determination that a switch configured to select between the Type 1 data resource pool type and the Type 2 data resource pool type has been set to indicate the Type 2 data resource pool type rather than the Type 2 data resource pool type; and overriding the nominal pool type selection and making a selection of the Type 2 data resource pool type in accordance with the determination.

In an example embodiment and mode the method further comprises the processor circuitry making the pool type selection of the selected data resource pool type on the basis of substantial non-availability of one of the data resource pool types.

In an example embodiment and mode the method further comprises the processor circuitry making the pool type selection of the selected data resource pool type on the basis of signaling information directing the wireless terminal to transmit the V2X communication using of one of the data resource pool types.

In an example embodiment and mode the method further comprises the processor circuitry making the pool type selection of the selected data resource pool type on the basis of a property of the V2X communication that renders one data resource pool type more appropriate than the other data resource pool type.

In an example embodiment and mode the method further comprises the processor circuitry making the pool type selection of the selected data resource pool type on the basis of a number of other wireless terminals in a vicinity of the wireless terminal being below a predetermined threshold.

In an example embodiment and mode the method further comprises the processor circuitry making the pool type selection of the selected data resource pool type on the basis of a determination that no data radio resources of one of the data resource pool types are configured for the wireless terminal.

In an example embodiment and mode the method further comprises the processor circuitry making the pool type selection of the selected data resource pool type on the basis of a switch configured to select between the Type 1 data resource pool type and the Type 2 data resource pool type.

In an example embodiment and mode the method further comprises receiving the information regarding the one or more Type 1 data resource pools and the one or more Type 2 data resource pools is obtained over a radio interface in (1) a broadcast message, or (2) radio resource control (RRC) signaling.

In an example embodiment and mode the information regarding the one or more Type 1 data resource pools and the one or more Type 2 data resource pools is configured in the memory of the wireless terminal.

In another of its aspects the technology disclosed herein concerns a node of a radio access network (RAN) comprising processor circuitry and a transmitter. The processor circuitry is configured to provide pool type selection information to a wireless terminal configured to participate in a vehicle (V2X) communication. The pool type selection information comprises criteria to facilitate selection by the wireless terminal between data radio resource pool Type 1 and data radio resource pool Type 2 as a selected data resource pool from which the wireless terminal selects a radio resource for the V2X communication. The one or more Type 1 data resource pools are classified as belonging to data resource pool

Type 1 and one or more Type 2 data resource pools are classified as belonging to data resource pool Type 2. The one or more Type 1 data resource pools consist of radio resources that are included in plural data resource pools and the one or more Type 2 data resource pools consist of radio resources that are included in only one of the plural Type 2 data resource pools. The transmitter is configured to transmit the pool type selection criteria information to the wireless terminal.

In an example embodiment and mode the transmitter is configured to transmit the pool type selection criteria information to the wireless terminal in a broadcast message.3.

In an example embodiment and mode transmitter is configured to transmit the pool type selection criteria information to the wireless terminal in a radio resource control (RRC) message.

In an example embodiment and mode the pool type selection information further is configured to direct the wireless terminal to transmit the V2X communication using of one of the data resource pool types.

In an example embodiment and mode the pool type selection information configures a switch configured used by the wireless terminal to select between the Type 1 data resource pool type and the Type 2 data resource pool type.

In an example embodiment and mode the node comprises another wireless terminal.

In an example embodiment and mode the node comprises a base station node.

Although the description above contains many specificities, these should not be construed as limiting the scope of the technology disclosed herein but as merely providing illustrations of some of the presently preferred embodiments of the technology disclosed herein. Thus the scope of the technology disclosed herein should be determined by the appended claims and their legal equivalents. Therefore, it will be appreciated that the scope of the technology disclosed herein fully encompasses other embodiments which may become obvious to those skilled in the art, and that the scope of the technology disclosed herein is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the technology disclosed herein, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A wireless terminal configured for use in vehicle (V2X) communications comprising:
a transmitter configured to send a V2X communication using a selected radio resource;
a memory configured to store information regarding data radio resources which belong to an overlapping data radio resource pool and data radio resources which belong to a non-overlapping data radio resource pool;
processor circuitry configured to make selection of the selected radio resource from among the overlapping data radio resource pool and the non-overlapping data radio resource pool.

2. The wireless terminal of claim 1, wherein:
the memory is configured to store information regarding the data radio resources each of which are classified in accordance with one of plural data radio resource pool types including data radio resource pool Type 1 and data radio resource pool Type 2, one or more Type 1 data resource pools being classified as belonging to data resource pool Type 1 and one or more Type 2 data resource pools being classified as belonging to data resource pool Type 2, the one or more Type 1 data resource pools consisting of radio resources that are included in plural data resource pools and the one or more Type 2 data resource pools consisting of radio resources that are included in only one of the plural Type 2 data resource pools;
the processor circuitry is configured to make a pool type selection of a selected data resource pool type from which the selected radio resource is selected; the selected resource pool type being either the Type 1 data resource pool type or the Type 2 data resource pool type.

3. The wireless terminal of claim 2, wherein the processor circuitry is configured to make a nominal pool type selection of a first of the one or more data radio resource pool types unless the processor circuitry determines a condition favoring a second of the one or more data radio resource pool types.

4. The wireless terminal of claim 2, wherein the processor circuitry is configured to make the pool type selection of the selected data resource pool type on the basis of substantial non-availability of one of the data resource pool types.

5. The wireless terminal of claim 2, wherein the processor circuitry is configured to make the pool type selection of the selected data resource pool type on the basis of signaling information directing the wireless terminal to transmit the V2X communication using of one of the data resource pool types.

6. The wireless terminal of claim 2, wherein the processor circuitry is configured to make the pool type selection of the selected data resource pool type on the basis of a property of the V2X communication that renders one data resource pool type more appropriate than the other data resource pool type.

7. The wireless terminal of claim 2, wherein the processor circuitry is configured to make the pool type selection of the selected data resource pool type on the basis of a number of other wireless terminals in a vicinity of the wireless terminal being below a predetermined threshold.

8. The wireless terminal of claim 2, wherein the processor circuitry is configured to make the pool type selection of the selected data resource pool type on the basis of a determination that no data radio resources of one of the data resource pool types are configured for the wireless terminal.

9. The wireless terminal of claim 2, wherein the processor circuitry is configured to make the pool type selection of the selected data resource pool type on the basis of a switch configured to select between the Type 1 data resource pool type and the Type 2 data resource pool type.

10. The wireless terminal of claim 2, further comprising a receiver, and wherein the information regarding the one or more Type 1 data resource pools and the one or more Type 2 data resource pools is obtained over a radio interface by the receiver in (1) a broadcast message, or (2) radio resource control (RRC) signaling.

11. The wireless terminal of claim 2, further comprising a receiver, and wherein the information regarding the one or more Type 1 data resource pools and the one or more Type 2 data resource pools is configured in the memory of the wireless terminal.

12. A method of operating a wireless terminal configured for use in vehicle (V2X) communications, the method comprising:
classifying data radio resources as belonging to one of an overlapping data radio resource pools and a non-overlapping data radio resource pool;
using processor circuitry to make selection of a selected radio resource from among the overlapping data radio resource pools and the non-overlapping data radio resource pool; and, transmitting a V2X communication using the selected radio resource.

13. The method of claim 12, further comprising:
wherein classifying the data radio resources as belonging to one of the overlapping data radio resource pools and the non-overlapping data radio resource pool comprises classifying the data radio resources in accordance with one of plural data radio resource pool types including data radio resource pool Type 1 and data radio resource pool Type 2, one or more Type 1 data resource pools being classified as belonging to data resource pool Type 1 and one or more Type 2 data resource pools being classified as belonging to data resource pool Type 2, the one or more Type 1 data resource pools consisting of radio resources that are included in plural data resource pools and the one or more Type 2 data resource pools consisting of radio resources that are included in only one of the plural Type 2 data resource pools;
using the processor circuitry to make a pool type selection of a selected data resource pool type from which a selected radio resource is selected; the selected resource pool type being either the Type 1 data resource pool type or the Type 2 data resource pool type.

14. The method of claim 13, further comprising the processor circuitry making a nominal pool type selection of a first of the one or more data radio resource pool types unless the processor circuitry determines a condition favoring a second of the one or more data radio resource pool types.

15. The method of claim 13, further comprising the processor circuitry making the pool type selection of the selected data resource pool type on the basis of substantial non-availability of one of the data resource pool types.

16. The method of claim 13, further comprising the processor circuitry making the pool type selection of the selected data resource pool type on the basis of signaling information directing the wireless terminal to transmit the V2X communication using of one of the data resource pool types.

17. The method of claim 13, further comprising the processor circuitry making the pool type selection of the selected data resource pool type on the basis of a property of the V2X communication that renders one data resource pool type more appropriate than the other data resource pool type.

18. The method of claim 13, further comprising the processor circuitry making the pool type selection of the selected data resource pool type on the basis of a number of other wireless terminals in a vicinity of the wireless terminal being below a predetermined threshold.

19. The method of claim 13, further comprising the processor circuitry making the pool type selection of the selected data resource pool type on the basis of a determination that no data radio resources of one of the data resource pool types are configured for the wireless terminal.

20. The method of claim 13, further comprising the processor circuitry making the pool type selection of the selected data resource pool type on the basis of a switch configured to select between the Type 1 data resource pool type and the Type 2 data resource pool type.

21. The method of claim 13, further comprising receiving the information regarding the one or more Type 1 data resource pools and the one or more Type 2 data resource pools is obtained over a radio interface by a receiver in (1) a broadcast message, or (2) radio resource control (RRC) signaling.

22. The method of claim 13, further comprising a receiver, and wherein the information regarding the one or more Type 1 data resource pools and the one or more Type 2 data resource pools is configured in the memory of the wireless terminal.

23. A node of a radio access network (RAN) comprising:
processor circuitry configured to provide pool type selection information to a wireless terminal configured to participate in a vehicle (V2X) communication, the pool type selection information comprising criteria to facilitate selection by the wireless terminal between data radio resource pool Type 1 and data radio resource pool Type 2 as a selected data resource pool from which the wireless terminal selects a radio resource for the V2X communication, one or more Type 1 data resource pools being classified as belonging to data resource pool Type 1 and one or more Type 2 data resource pools being classified as belonging to data resource pool Type 2, the one or more Type 1 data resource pools consisting of radio resources that are included in plural data resource pools and the one or more Type 2 data resource pools consisting of radio resources that are included in only one of the plural Type 2 data resource pools;
a transmitter configured to transmit the pool type selection criteria information to the wireless terminal.
